(19) United States
(12) Patent Application Publication
(10) Pub. No.: US 2014/0136271 A1
(43) Pub. Date: May 15, 2014

(54) ASSORTMENT PACK BUILDER

(71) Applicant: TARGET BRANDS, INC., Minneapolis, MN (US)

(72) Inventors: Bharath Rangarajan, Minneapolis, MN (US); Lisa Anne Miller, Roseville, MN (US)

(73) Assignee: TARGET BRANDS, INC., Minneapolis, MN (US)

(21) Appl. No.: 13/676,842

(22) Filed: Nov. 14, 2012

(51) Int. Cl. G06Q 10/06

(52) U.S. Cl. CPC G06Q 10/06315
USPC 705/7.25

(57) ABSTRACT

A first set of a plurality of assortment packs that include a plurality of different versions of an item to be sold at a plurality of retail stores is determined based at least in part on forecasted sales of the item at each of the plurality of retail stores. Each retail store is associated with an assortment pack based at least in part on the forecasted sales of the item at the retail store such that the plurality of retail stores is grouped into a plurality of clusters of retail stores. The distribution of the different versions of the item of at least one of the plurality of assortment packs is changed based at least in part on the forecasted sales of the item at each retail store of the cluster of retail stores with which the at least one of the plurality of assortment packs has been associated.

### BACKGROUND

Consumers may purchase various products via retail stores. The retail stores may request (i.e., order) various versions of any particular product for placement in the retail stores based on forecasted sales of the item at the retail store. For example, a retail store may order a particular style of shirt based on forecasted sales of seventy large shirts, one hundred medium shirts, and forty small shirts over a given period of time (e.g., six weeks). The vendor may ship the ordered products to the retail store using an assortment pack. The assortment pack may represent one or more physical packages (e.g., boxes) containing the ordered products. To this end, a substantial portion of a product for a forecasted time period (e.g., a season) may be shipped to a retail store via one shipment of an assortment pack.

Larger stores, or so-called “retail chains,” may include numerous (e.g., hundreds or thousands) individual retail stores located across the country or, in certain examples, the world. As the number of individual retail stores in these retail chains increases, the contents of assortment packs as well as the assignment of the assortment pack to a particular retail store of the chain is becoming a more relevant, complex, and intricate inquiry.

### SUMMARY

This disclosure relates to techniques for determining both the contents of assortment packs and the selection of one or more retail stores to which a particular assortment pack is delivered. In one example, a method includes determining, with a computing device, a first set of a plurality of assortment packs that include a plurality of different versions of an item to be sold at a plurality of retail stores based at least in part on forecasted sales of the item at each of the plurality of retail stores. Each of the plurality of assortment packs of the first set of the plurality of assortment packs may include a different distribution of the different versions of the item. The method also includes, for each retail store of the plurality of retail stores, associating, with the computing device, the retail store with an assortment pack of the first set of the plurality of assortment packs based at least in part on the forecasted sales of the item at the retail store such that the plurality of retail stores is grouped into a first plurality of clusters of retail stores. The method also includes changing, with the computing device, the distribution of the different versions of the item of at least one of the plurality of assortment packs of the first set of the plurality of assortment packs based at least in part on the forecasted sales of the item at each retail store of the cluster of retail stores of the first plurality of clusters of retail stores with which the at least one of the plurality of assortment packs of the first set of the plurality of assortment packs has been associated so as to determine a second set of a plurality of assortment packs. The method also includes determining, with the computing device, a third set of a plurality of assortment packs that include a plurality of different versions of the item to be sold at the plurality of retail stores based at least in part on forecasted sales of the item at each of the plurality of retail stores. Each of the plurality of assortment packs of the third set of the plurality of assortment packs may include a different distribution of the different versions of the item. The third set of the plurality of assortment packs may be different than the first set of the plurality of assortment packs. The method also includes, for each retail store of the plurality of retail stores, associating, with the computing device, the retail store with an assortment pack of the third set of the plurality of assortment packs based at least in part on the forecasted sales of the item at the retail store such that the plurality of retail stores is grouped into a second plurality of clusters of retail stores. The method also includes changing, with the computing device, the distribution of the different versions of the item of at least one of the plurality of assortment packs of the third set of the plurality of assortment packs based at least in part on the forecasted sales of the item at each retail store of the cluster of retail stores of the second plurality of clusters of retail stores with which the at least one of the plurality of assortment packs of the third set of the plurality of assortment packs has been associated so as to determine a fourth set of a plurality of assortment packs. The method also includes comparing, with the computing device, the second set of the plurality of assortment packs and the fourth set of the plurality of assortment packs, and selecting, with the computing device, one of the second set of the plurality of assortment packs and the fourth set of the plurality of assortment packs based on the comparison.

In another example, a computing device includes at least one computer-readable storage device. The computing device also includes at least one processor configured to access information stored on the at least one computer-readable storage device and to perform operations comprising determining a first set of assortment packs that include a plurality of different versions of an item to be sold at a plurality of retail stores based at least in part on forecasted sales of the item at each of the plurality of retail stores. The operations also include, for each retail store of the plurality of retail stores, associating the retail store with an assortment pack of the first set of assortment packs based at least in part on the forecasted sales of the item at the retail store such that the plurality of retail stores is grouped into a first plurality of clusters of retail stores. The operations also include changing a distribution of the different versions of the item of at least one of the plurality of assortment packs of the first set of assortment packs based at least in part on the forecasted sales of the item at each retail store of the cluster of retail stores of the first plurality of clusters of retail stores with which the at least one of the plurality of assortment packs of the first set of assortment packs has been associated so as to determine a second set of assortment packs. The operations also include determining a third set of assortment packs that include a plurality of different versions of the item to be sold at the plurality of retail stores based at least in part on forecasted sales of the item at each of the plurality of retail stores. The operations also include, for each retail store of the plurality of retail stores, associating the retail store with an assortment pack of the third set of assortment packs based at least in part on the forecasted sales of the item at the retail store such that the plurality of retail stores is grouped into a second plurality of clusters of retail stores. The operations also include changing a distribution of the different versions of the item of at least one of the plurality of assortment packs of the third set of assortment packs based at least in part on the forecasted sales of the item at each retail store of the cluster of retail stores of the second plurality of clusters of retail stores with which the at least one of the plurality of assortment packs of the third set of assortment packs has been associated so as to determine a fourth set of assortment packs. The operations also include comparing the second set of assortment packs and the fourth set of assortment packs, and selecting one of the second set of assortment packs and the fourth set of assortment packs based on the comparison.

In another example, a computer-readable storage device is encoded with instructions that, when executed, cause one or more processors of a computing device to determine a first set of assortment packs that include a plurality of different items to be sold at a plurality of retail stores based at least in part on forecasted sales of the items at each of the plurality of retail stores. The computer-readable store device is also encoded with instructions that, when executed, cause the one or more processors of the computing device to, for each retail store of the plurality of retail stores, associate the retail store with an assortment pack of the first set of assortment packs based at least in part on the forecasted sales of the items at the retail store such that the plurality of retail stores is grouped into a first plurality of clusters of retail stores, and change the items of at least one of the plurality of assortment packs of the first set of assortment packs based at least in part on the forecasted sales of the items at each retail store of the cluster of retail stores of the first plurality of clusters of retail stores with which the at least one of the plurality of assortment packs of the first set assortment packs has been associated so as to determine a second set assortment packs. The computer-readable store device is also encoded with instructions that, when executed, cause the one or more processors of the computing device to determine a third set assortment packs that include a plurality of different items to be sold at the plurality of retail stores based at least in part on forecasted sales of the items at each of the plurality of retail stores. The third set of the plurality of assortment packs may be different than the first set. The computer-readable store device is also encoded with instructions that, when executed, cause the one or more processors of the computing device to, for each retail store of the plurality of retail stores, associate the retail store with an assortment pack of the third set of assortment packs based at least in part on the forecasted sales of the items at the retail store such that the plurality of retail stores is grouped into a second plurality of clusters of retail stores, and change the items of at least one of the plurality of assortment packs of the third set of assortment packs based at least in part on the forecasted sales of the items at each retail store of the cluster of retail stores of the second plurality of clusters of retail stores with which the at least one of the plurality of assortment packs of the third set of assortment packs has been associated so as to determine a fourth set of assortment packs. The computer-readable store device is also encoded with instructions that, when executed, cause the one or more processors of the computing device to select one of the second set of assortment packs and the fourth set of assortment packs based on a comparison of a difference between the items of each assortment pack in the second set of assortment packs and the forecasted sales of the items at each retail store of the cluster of retail stores of the first plurality of clusters of retail stores with which each assortment pack has been associated and a difference between the items of each assortment pack in the fourth set of assortment packs and the forecasted sales of the items at each retail store of the cluster of retail stores of the second plurality of clusters of retail stores with which each assortment pack has been associated.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example distribution of assortment packs from a vendor to multiple retail stores.

FIG. 2 is a conceptual diagram illustrating an example computing device that may be used to determine a plurality of assortment packs and, for each of a plurality of retail stores, associate the retail store with one of the plurality of assortment packs.

FIG. 3 is a block diagram illustrating further details of one example of a computing device as shown in FIG. 2.

FIG. 4 is a flow diagram illustrating example operations of a computing device to determine a plurality of assortment packs and, for each of a plurality of retail stores, associate the retail store with one of the plurality of assortment packs.

FIG. 5 is a flowchart illustrating example operations of a computing device to determine a plurality of assortment packs and, for each of a plurality of retail stores, associate the retail store with one of the plurality of assortment packs.

### DETAILED DESCRIPTION

In general, aspects of this disclosure are directed to techniques for determining both the contents of assortment packs and the selection of one or more retail stores to which a particular assortment pack is delivered. A retail chain may offer a product or a suite of products (or “program”) for sale at one or more individual retail stores. A retail chain may be a business entity that controls or otherwise operates multiple retail store locations. The retail chain may order the products from a vendor to be shipped directly to each individual retail store. In certain examples, the retail chain may order the products to be shipped to the individual retail stores as an assortment pack that represents one or more physical packages (e.g., boxes) that include the ordered products. The retail chain may designate the contents of the assortment pack to be sent to the retail store based on forecasted sales of the product or versions of the product at the retail store. In addition, the number of products included in the assortment pack may be determined based on forecasted sales for the product over a particular time period, such as a number days, weeks, or months. As one example, the retail chain may designate an assortment pack that represents a distribution of different sizes and colors of shorts for the summer season. The quantity of each of the different versions of the shorts (i.e., the different colors and sizes in this example) may be based on forecasted sales of each of those versions at a particular retail store.

By ordering products from a vendor using assortment packs, the retail chain may help to decrease the cost of shipping the products to the individual retail store. For instance, because each shipping transaction may incur separate fees, it may be more cost effective to ship one assortment pack that includes a larger quantity of products than to ship multiple, smaller packages. In addition, by designating the contents of the assortment pack based on forecasted sales of the product for which the products are expected to be in high demand (e.g., a summer season for clothes typically worn during the summer, such as shorts, t-shirts, baseball caps, and the like), the retail chain may help to minimize the number of unsold products at the retail store as well as any deficiency in the number of products that may result in lost sales opportunities of the products.

However, the forecasted sales of a product, as well as the forecasted sales of different versions of the product (e.g., sizes, colors, styles etc.) may differ between individual retail stores of the retail chain. As such, the forecasted distribution of products (e.g., a number of large, medium, and small sizes of a particular article of clothing) may differ among individual retail stores. For instance, a retail store located in California may forecast a larger number of sales of a small size of a particular shirt than a retail store in Minnesota. Similarly, a retail store in Maine may forecast a smaller number of sales of a particular style of pant than a retail store in Arizona. As such, the distribution of different versions of a product included in an assortment pack sent to one retail store may differ from the distribution of the different versions of the product included in an assortment pack sent to another retail store.

In a business setting, however, a vendor may place constraints on the number of assortment packs that may be assembled for the retail chain. For example, a vendor may incur costs associated with decreased efficiency in assembling the assortment packs for delivery as the number of assortment packs increases, e.g. as the number of different versions of assortment packs designed for particular retail stores in the retail chain increases. As such, in an example, a vendor may agree to assemble twenty different assortment packs of varying distributions of versions of a product, but may not agree to assemble fifty different assortment packs. Moreover, the number of assortment packs that a vendor agrees to assemble may differ between vendors. As such, in examples where the retail chain includes more retail stores than the number of different assortment packs available for assembly, a retail chain may order the same assortment pack to be delivered to multiple retail stores.

Techniques described herein may enable a retail chain to designate the contents of multiple assortment packs and the selection of one or more retail stores to which a particular assortment pack is delivered. According to various techniques of this disclosure, a computing device may determine a set of assortment packs to be sold at multiple retail stores. Each of the assortment packs may include a different distribution of different versions of an item to be sold at the multiple retail stores. The computing device may associate each of the retail stores with an assortment pack. For example, the computing device may determine a closeness of fit between a distribution of forecasted sales of the different versions of the item at the retail store and the distribution of the different versions of the item included in an assortment pack. For instance, for a particular retail store, the computing device may determine the closeness of fit with respect to each of the assortment packs, and may associate the retail store with the assortment pack that best fits the forecasted sales of the retail store. In such a way, the computing device may associate each of the retail stores with one of the multiple assortment packs so as to group the retail stores into clusters. Each cluster may include those retail stores that are associated with a same assortment pack.

For each cluster of retail stores, the computing device may change the distribution of the different versions of the item included in the assortment pack. For example, the computing device may adjust the distribution of the different versions of the item included in the assortment pack to better fit the forecasted sales of the different versions of the item among the retail stores of the cluster. In some examples, the computing device may adjust the distribution of the different versions of the item included in the assortment pack based on one or more constraints, such as a maximum number of items included in the assortment pack (e.g., based on a maximum weight capacity of a box within which the assortment pack may be shipped), a minimum number of items or version of an item included in the assortment pack (e.g., a minimum number of shirts, a minimum number of small, medium, and large sized shirts, a minimum number of a color of each size of shirt, etc.), or other constraints. As such, the computing device may better fit the distribution of items of each assortment pack to the requirements of the retail stores to which the assortment pack may be shipped, thereby possibly reducing the number of overstocked and understocked items at each of the retail stores.

In certain examples, the computing device may continue to cluster the retail stores and change the distribution of the versions of the item included in the assortment pack in an iterative manner until a stopping condition is satisfied. For instance, the computing device may group the retail stores into clusters of stores associated with an assortment pack, change the distribution of different versions of the items included in the assortment pack for each cluster, re-group the retail stores into clusters based on the changed distributions of the items in the assortment packs, re-adjust the distribution of different versions of the item, and so on until a stopping condition, such as a maximum number of iterations or threshold closeness of fit between the distribution of the item in the assortment pack and the forecasted sales of the item at each of the stores in a cluster, is satisfied. In such a way, the computing device may possibly further reduce the number of overstocked and understocked items at each of the retail stores, thereby helping to minimize the costs associated with unsold items and lost sales opportunities, reduction of one or both of which may, in turn, improve sales and profit of the retailer.

In some examples, the computing device may perform multiple such optimizations and compare the results of each optimization to select a further optimized set of assortment packs and associations with retail stores. For example, the computing device may perform a first iterative optimization (e.g., determination of the set of assortment packs, clustering retail stores to an assortment pack, adjusting the distributions of the assortment packs based on the clusters, re-clustering, re-adjusting the distributions, etc.) beginning with a first set of initial conditions (e.g., a first distribution of the items in the assortment packs, a first number of assortment packs, and the like). The computing device may perform a second iterative optimization using a second set of initial conditions, such as a second distribution of the items in the assortment packs that is different from the first distribution, a second number of assortment packs that is different than the first number of assortment packs, or other different initial conditions. In some examples, the computing device may perform the first and second optimizations using differing constraints, such as a different maximum number of assortment packs, a different maximum number of items included in any one assortment pack, or other constraints that are different as between the first and second optimizations. The first and second optimizations may be performed synchronously or asynchronously. The computing device may compare the results of the first and second optimizations (e.g., the distributions of the different versions of the items included in the assortment packs and the associations of the assortment packs with the plurality of retail stores) and may select one of the optimizations. In certain examples, the computing device may perform more than two optimizations synchronously or asynchronously, such as three, five, ten, or more optimizations. As such, the computing device may select, from among multiple optimizations performed with different initial conditions, a result that best fits the forecasted sales of the retail stores and the defined constraints.

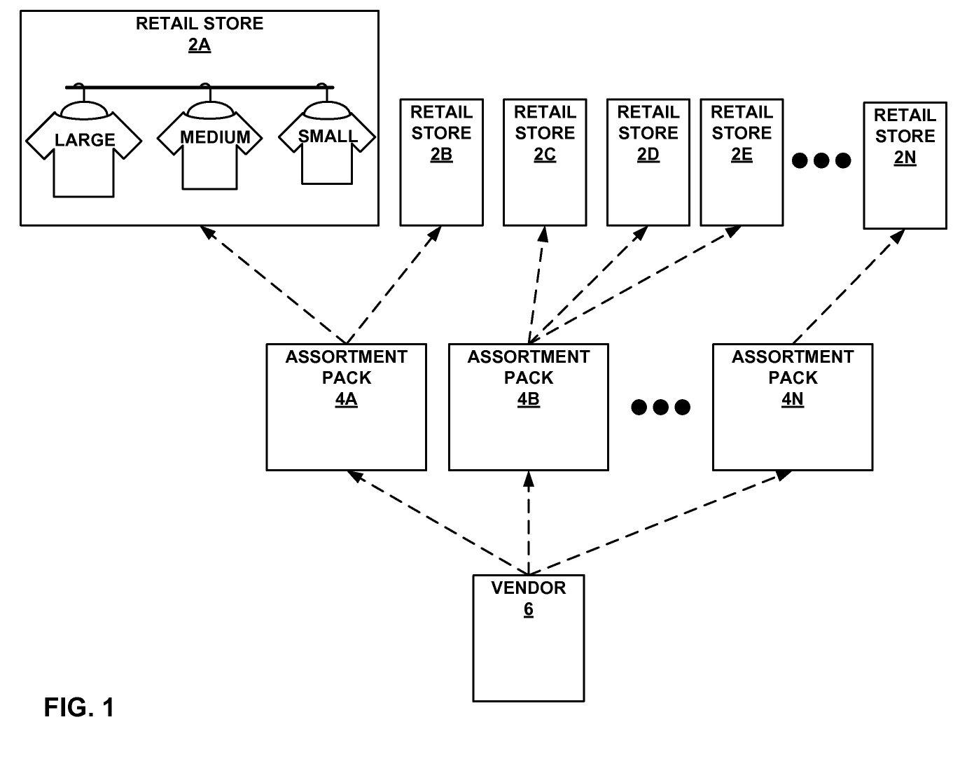

FIG. 1 is a conceptual diagram illustrating an example distribution of assortment packs 4A-4N (collectively referred to herein as “assortment packs 4”) from vendor 6 to multiple retail stores 2A-2N (collectively referred to herein as “retail stores 2”). As illustrated in FIG. 1, vendor 6 may assemble assortment packs 4, each of assortment packs 4 including different versions of an item to be sold at retail stores 2. Each of assortment packs 4 may be one or more physical packages (e.g., boxes) that include a plurality of different versions of the item to be sold at one or more of retail stores 2. For instance, as shown in FIG. 1, vendor 6 may assemble assortment pack 4A, including a distribution of large, medium, and small sizes of a particular style of shirt to be sold at retail stores 2A and 2B. Similarly, vendor 6 may assemble assortment pack 4B including a plurality of different versions of an item to be sold at retail stores 2C. 2D, and 2E.

Assortment pack 4B may include a different distribution of the item included in assortment pack 4A. For instance, assortment pack 4B may include a different distribution of large, medium, and small sizes of the style of shirt included in assortment pack 4A (e.g., a different number of one or more of the large, medium, and small sizes of the style of shirt). As illustrated, vendor 6 may assemble a plurality of assortment packs, such that the set of assortment packs 4 may include any number of assortment packs (e.g., two assortment packs, five assortment packs, twenty assortment packs, or other numbers of assortment packs).

Although illustrated with respect to a distribution of different versions of a single item (e.g., a distribution of different sizes of shirts in this example), it should be understood that techniques of this disclosure are not so limited. For example, one or more of assortment packs 4 may include distributions of multiple different items, such as shirts, pants, towels, tennis rackets, and the like. In general, techniques of the present disclosure may be applicable to assortment packs including any item that includes an assortment of versions of the item. For instance, one or more of assortment packs 4 may include multiple items with multiple distributions of different versions of the items, such as varying sizes, colors, styles, etc.

In some examples, a retail chain may order assortment packs 4 from vendor 6 to be shipped to retail stores 2. The retail chain may be a business entity that controls or otherwise operates multiple retail store locations, such as the set of retail stores 2. The retail chain may designate the number of assortment packs to be assembled by vendor 6, the contents of each assortment pack, and one or more retail stores to which each assortment pack is to be delivered.

The retail chain may determine the set of assortment packs 4 based on forecasted sales of one or more items at retail stores 2. For example, each of retail stores 2 may forecast a number of sales of an item (e.g., a style of shirt) over a period of time, such as a number of days, weeks, months, or other amounts of time. In addition, each of retail stores 2 may forecast a number of sales of different versions of the item for the period of time. As one example, retail store 2A may forecast sales of fifty large-sized shirts, one hundred medium-sized shirts, and thirty small-sized shirts of a particular style over a period of six weeks. In such an example, the retail chain may determine the contents of assortment pack 4A based at least in part on the forecasted distribution of shirts at retail store 2A.

However, as discussed above, forecasted sales of an item or different versions of the item may differ among the set of retail stores 2. For instance, retail store 2C may forecast sales of ten large-sized shirts of a particular style over a period of eight weeks, and retail store 2B may forecast one hundred sales of large-sized shirts of the same style for the same eight-week period. In such an example, the retail chain may determine one assortment pack for delivery to retail store 2A (e.g., assortment pack 4A) including a distribution of the sizes of the shirt based on the forecasted sales of the sizes of the shirt at retail store 2A. In addition, the retail chain may determine a different assortment pack for delivery to retail store 2C (e.g., assortment pack 4B) including a different distribution of the sizes of the shirt based on forecasted sales of the sizes of the shirt at retail store 2C.

In such a way, the retail chain may determine a set of a plurality of assortment packs 4 that include a plurality of different versions of an item to be sold at a plurality of retail stores 2. In some examples, each of assortment packs 4 may include a different distribution of the different versions of the item. For instance, in certain examples, each of retail stores 2 may forecast a different distribution of the different versions of the item. As such, the retail chain may determine the set of assortment packs 4 based on the forecasted sales of the different versions of the item at each of retail stores 2.

In a business setting, however, it may be impractical for a vendor to assemble a number of assortment packs equal to the number of retail stores in the retail chain. For example, the set of retail stores 2 may include numerous (e.g., hundreds or thousands) of individual retail stores. A vendor (e.g., vendor 6) may incur costs associated with decreased efficiency in assembling the assortment packs as the number of assortment packs increases. The increased cost of assembling the assortment packs may be distributed among one or more of the vendor, the retail chain, the individual retail store, and the consumer. As such, the increased cost associated with assembling the assortment packs may effectively constrain the number of assortment packs that can be included in the set of assortment packs 4 in a cost-effective manner.

As one example, the set of retail stores 2 may include one thousand individual retail stores. However, in such an example, the retail chain may determine that the cost of assembling the set of assortment packs 4 is too great when the set of assortment packs 4 exceeds a threshold number, such as twenty assortment packs. Accordingly, in certain examples, the retail chain may determine the set of assortment packs 4 such that the number of assortment packs 4 is less than the number of retail stores 2.

The retail chain may associate each of assortment packs 4 with one or more of retail stores 2. The association may designate the assortment pack for delivery to the retail store with which the assortment pack is associated. For instance, as shown in FIG. 1, assortment pack 4A may be associated with each of retail stores 2A and 2B. Similarly, assortment pack 4B may be associated with each of retail stores 2C, 2D, and 2E. The retail chain may associate each of the set of assortment packs 4 with one or more of retail stores 2, such that each of assortment packs 4 is associated with at least one retail store. Vendor 6 may assemble each of assortment packs 4 for delivery to retail stores 2 according to the determined associations between the set of assortment packs 4 and retails stores 2.

When the set of retail stores 2 outnumbers the set of assortment packs 4, the retail chain may associate at least one of assortment packs 4 with a plurality of retail stores 2. The groups of retail stores with which one assortment pack is associated may be referred to in the following examples as “clusters” of retail stores. The distribution of different versions of an item included in such an assortment pack (i.e., an assortment pack associated with a plurality of retail stores) may be determined based at least in part on the forecasted sales of the different versions of the item at each of the retail stores with which the assortment pack is associated. In addition, the assortment pack may be associated with a particular retail store based at least in part on a difference between the distribution of the different versions of the item included in the assortment pack and forecasted sales of the different versions of the item at each of the retail stores.

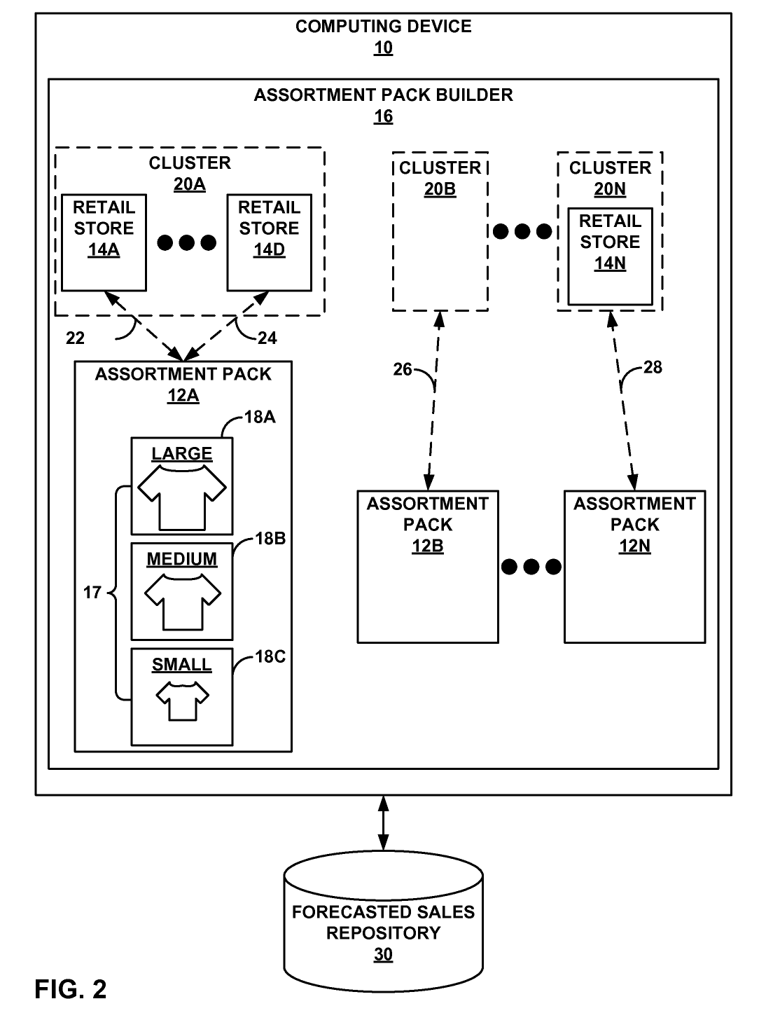

FIG. 2 is a conceptual diagram illustrating an example computing device 10 that may be used to determine a plurality of assortment packs and, for each of a plurality of retail stores, associate the retail store with one of the plurality of assortment packs. Examples of computing device 10 may include, but are not limited to, computing devices such as desktop computers, workstations, network terminals, and portable or mobile devices such as personal digital assistants (PDAs), mobile phones (including smart phones), tablet computers, laptop computers, netbooks, ultrabooks, and others.

As illustrated in FIG. 2, computing device 10 may include assortment pack builder 16. Assortment pack builder 16 may include any software or hardware process configured for executing various techniques described herein. For example, assortment pack builder 16 may include one or more computer-executable instructions stored at one or more computer-readable storage devices and executable by one or more processors of computing device 10. In some examples, one or more of the functions of assortment pack builder 16 may be included in hardware components, such as one or more processors, digital signal processors (DSP), application specific integrated circuits (ASIC), or other discrete or integrated logic circuitry. Similarly, although illustrated with respect to one computing device for ease of discussion, in certain examples, one or more of the functions of computing device 10 and/or assortment pack builder 16 may be distributed among multiple computing devices. For instance, one or more of the functions of computing device 10 and/or assortment pack builder 16 may be distributed among multiple workstations, desktop computers, laptop computers, and the like.

Assortment pack builder 16 may, according to techniques of this disclosure, determine a plurality of assortment packs 12A-12N (collectively referred to herein as “assortment packs 12”) that include a plurality of different versions of an item to be sold at a plurality of retail stores 14A-14N (collectively referred to herein as “retail stores 14”). For instance, as illustrated in FIG. 2, assortment pack 12A may include a distribution 17 of large shirts 18A, medium shirts 18B, and small shirts 18C (collectively referred to herein as “items 18”). In addition, according to techniques described herein, assortment pack builder 16 may associate each of retail stores 14 with one of assortment packs 12 such that the plurality of retail stores 14 is grouped into a plurality of clusters of retail stores 20A-20N (collectively referred to herein as “clusters 20”).

For example, as shown in FIG. 2, assortment pack builder 16 may associate assortment pack 12A with retail store 14A using association 22. Similarly, assortment pack builder 16 may associate assortment pack 12A with retail store 2D using association 24. Assortment pack builder 16 may associate each of retail stores 14 with one of assortment packs 12 such that the plurality of retail stores 14 is grouped into the plurality of clusters 20. For instance, cluster 20B of FIG. 2 may include one or more retail stores (not shown for ease of illustration). Assortment pack builder 16 may associate assortment pack 12B with each of the retail stores of cluster 20B using one or more associations 26. Similarly, assortment pack builder 16 may associate assortment pack 12N with retail store 14N of cluster 20N using association 28. Each cluster of retail stores included in the set of clusters 20 may include a plurality of retail stores 14 that have each been associated with the same assortment pack of the plurality of assortment packs 12. Thus, a cluster of retail stores may be defined in examples according to this disclosure as a group of retail stores associated with the same assortment pack.

Assortment pack builder 16 may generate each of assortment packs 12, retail stores 14, distribution 17, items 18, and clusters 20 as data structures or other representations of physical entities. That is, each of assortment packs 12, retail stores 14, distribution 17, items 18, and clusters 20 may be data structures or other representations stored in one or more computer-readable storage devices (e.g., computer-readable memory) accessible by computing device 10 to represent physical entities, e.g., boxes or other packaging associated with the assortment pack distribution process between a vendor and individual retail stores. Similarly, associations 22, 24, 26, and 28 may be associations designated using such computer-readable storage device(s) to represent a delivery of the assortment pack to one or more of retail stores 20.

Assortment pack builder 16 may determine the set of assortment packs 12 based at least in part on forecasted sales of items 18 at each of retail stores 14. For example, assortment pack builder 16 may access forecasted sales repository 30 to determine the forecasted sales of items 18 at each of retail stores 14. The forecasted sales may include predicted sales of the items at a future date or over a future time period. The forecasted sales may be determined based on past sales of the items at one or more of the retail stores, predictive factors such as predicted weather patterns, upcoming holidays, or other factors.

Forecasted sales repository 30 may include, in some examples, one or more databases, such as relational databases, multi-dimensional databases, hierarchical databases, object-oriented databases, or one or more other types of databases. Forecasted sales repository 30 may be part of computing device 10, one or more other computing devices remote from computing device 10, or distributed among computing device 10 and one or more remote computing devices. In certain examples, forecasted sales repository 30 may determine the forecasted sales of one or more items at one or more retail stores. In general, forecasted sales repository 30 may include any software and/or hardware process and any organizational structure that enables computing device 10 to determine forecasted sales of one or more items (e.g., items 18) at one or more of retail stores 14.

Assortment pack builder 16 may access forecasted sales repository 30 to determine the forecasted sales of items 18 at each of retail stores 14. Assortment pack builder 16 may determine the set of assortment packs 12 based at least in part on the forecasted sales of items 18. As one example, for a particular period of time (e.g., six weeks), retail store 14A may forecast seventy sales of large shirts 18A, one hundred sales of medium shirts 18B, and forty sales of small shirts 18C; retail store 14D may forecast sixty sales of large shirts 18A, ninety sales of medium shirts 18B, and forty-five sales of small shirts 18C; and retail store 14N may forecast twenty sales of large shirts 18A, thirty sales of medium shirts 18B, and sixty sales of small shirts 18C. Assortment pack builder 16 may determine the set of assortment packs 12 based on the forecasted sales of items 18 at each of retail stores 14, such as by determining the distribution of items 18 (e.g., the number of each of large shirts 18A, medium shirts 18B, and small shirts 18C included in the assortment pack) based on the forecasted sales.

Assortment pack builder 16 may associate each of retail stores 20 with one of assortment packs 12 such that the plurality of retail stores 14 is grouped into the plurality of clusters of retail stores 20. In certain examples, assortment pack builder 16 may associate each of retail stores 20 with one of assortment packs 12 based on a difference between a distribution of different versions of the items included in the assortment pack and a distribution of forecasted sales of the different versions of the item at the retail store.

As one example, assortment pack builder 16 may compare distribution 17 of items 18 (e.g., a number of each of items 18 included in assortment pack 12A) with forecasted sales of each of items 18 at retail store 14A. Assortment pack builder 16 may determine a plurality of differences of the number of the version of the item based on the comparison. For instance, assortment pack builder 16 may determine a difference between the number of large shirts 18A included in assortment pack 12A and the forecasted sales of large shirts 18A at retail store 14A. Similarly, assortment pack builder 16 may determine a difference between the number of each of medium shirts 18B and small shirts 18C included in assortment pack 12A and the forecasted sales of each of medium shirts 18B and small shirts 18C at retail store 14A.

Assortment pack builder 16 may associate retail store 14A with assortment pack 12A based on the plurality of determined differences. For instance, assortment pack builder 16 may determine a plurality of differences between forecasted sales of items 18 at retail store 14A and the number of items 18 included in each of assortment packs 12. In some examples, assortment pack builder 16 may associate retail store 14A with one of assortment packs 12 based at least in part on minimizing the determined differences between the forecasted sales of items 18 at retail store 14A and the number of each of items 18 included in each of assortment packs 12.

As one example, minimizing differences may be based on an average difference between the number of each of items 18 included in the assortment pack and the number of forecasted sales of each of items 18 at retail store 14A. For instance, assortment pack builder 16 may determine a plurality of differences of items included in assortment pack 12A and forecasted sales of items 18 at retail store 14A as a difference of five of large shirts 18A, a difference of ten of medium shirts 18B, and a difference of fifteen of small shirts 18C. In such an example, assortment pack builder 16 may determine an average difference often items between the distribution of items 18 included in assortment pack 12A and forecasted sales of items 18 at retail store 14A. In such a way, assortment pack builder 16 may determine a plurality of differences between forecasted sales of items 18 at retail store 14A and each of assortment packs 12.

In certain examples, assortment pack builder 16 may associate retail store 14A with the assortment pack of the set of assortment packs 12 that is associated with the least average difference of numbers of items forecasted to be sold versus supplied in the assortment pack. In certain examples, assortment pack builder 16 may determine the average difference based on a weighted average, a moving weighted average, or other central tendency techniques. As such, assortment pack builder 16 may associate a retail store (e.g., retail store 14A) with one of assortment packs 12 (e.g., assortment pack 12A) based on a closeness of fit between a distribution of forecasted sales of different versions of an item at the retail store and the distribution of different versions of the item included in the assortment pack (e.g., distribution 17 of items 18 included in assortment pack 12A). Assortment pack builder 16 may associate each of retail stores 14 with one of assortment packs 12 such that the plurality of retail stores 14 is grouped into a plurality of clusters of retail stores 20, each of the clusters including a plurality of retail stores that have each been associated with the same assortment pack of the plurality of assortment packs.

Assortment pack builder 16 may change the distribution of the different versions of the item of at least one of the plurality of assortment packs 12 based at least in part on the forecasted sales of the item at each retail store of the cluster of retail stores with which the at least one of the plurality of assortment packs has been associated. In such a way, assortment pack builder 16 may determine a second set of the plurality of assortment packs.

For instance, in the example of FIG. 2, assortment pack builder 16 may change distribution 17 of items 18 included in assortment pack 12A based on forecasted sales of items 18 at each of retail stores 14A-14D included in cluster 20A. As an example, assortment pack builder 16 may determine a difference between distribution 17 (e.g., a number of each of items 18 included in assortment pack 12A) and a distribution of forecasted sales of items 18 (e.g., a number of forecasted sales of each of items 18) at retail store 14A. Similarly, assortment pack builder 16 may determine distribution differences between distribution 17 and a distribution of forecasted sales of items 18 at each of retail stores 14A-14D so as to determine a plurality of distribution differences. Assortment pack builder 16 may change distribution 17 based at least in part on minimizing each distribution difference of the plurality of determined distribution differences.

For example, assortment pack builder 16 may change the number of large shirts 18A included in assortment pack 12A to the average number of forecasted sales of large shirts 18A among retail stores 14A-14D included in cluster 20A. Similarly, assortment pack builder 16 may change the number of each of medium shirts 18B and small shirts 18C included in assortment pack 12A based on the forecasted sales of each of medium shirts 18B and small shirts 18C among the retail stores included in cluster 20A. Assortment pack builder 16 may change the distribution of items 18 included in one or more of assortment packs 12 based on forecasted sales of items 18 at each retail store of the cluster of retail stores with which the assortment pack has been associated. As such, assortment pack builder 16 may help to optimize the number of items 18 included in each of assortment packs 12 by changing the distribution of different versions of items included in each assortment pack to better fit the forecasted sales of the item at the retail stores to which the assortment pack is designated for delivery (e.g., the retail stores of the cluster with which the assortment pack is associated), thereby helping to reduce costs associated with overstocking and understocking the item at the retail store.

In some examples, assortment pack builder 16 may determine and/or change the distribution of the different versions of the item included in an assortment pack based on one or more factors or constraints, such as a minimum number of each of the different versions of the item, a maximum number of each of the different versions of the item, a forecasted sales of each of the different versions of the item for a configurable period of time, a maximum number of items in the assortment pack, a maximum number of assortment packs, and the like. As one example, assortment pack builder 16 may determine a minimum number of one or more of items 18 included in assortment pack 12A. Such a minimum number may be described as a “presentation minimum.” That is, a retail chain, retail store, or assortment pack builder 16 may determine a minimum number of a particular item (e.g., a minimum number of large shirts 18A) that may be presented at a retail store for purchase by customers. For instance, it may be that retail store 14A forecasts sales of twenty large shirts 18A, thirty medium shirts 18B, and one small shirt 18C. In such an example, the retail chain or retail store may determine that a presentation of only one small shirt 18C on a rack in the retail store is aesthetically unpleasing, or otherwise undesirable. As such, a presentation minimum number may be determined or set for one or more of the items included in the assortment pack. In such examples, assortment pack builder 16 may include at least the presentation minimum number of each item in an assortment pack or at least the presentation minimum plus some number of additional items over and above the presentation minimum.

As another example, the forecasted sales of each of the different versions of the item at one or more of retail stores 14 may be based on a configurable period of time. For example, the forecasted sales of items 18 at one or more retail stores 14 may be based on different, configurable periods of time. For instance, retail store 14A may forecast sales of items 18 for three weeks, and retail store 14N may forecast sales of items 18 for six weeks. The different time periods may be representative of a period of time for which the retail store requests inventory of items 18. For instance, a retail store located in California may forecast sales of shorts for a period of time that is greater than a forecasted time period of a retail store in Alaska because the selling season is longer for shorts in California than in Alaska. As such, assortment pack builder 16 may determine the distribution of items included in an assortment pack based on the configurable forecasted period of time or different periods of time across different stores.

For example, one or more of a minimum number of weeks of supply of an item, a maximum number of weeks of supply of an item may be determined or set with respect to each of retail stores 14. Assortment pack builder 16 may use the maximum number of weeks of supply and minimum number of weeks of supply as a constraint when optimizing the distribution of the different versions of the item included in each assortment pack, the number of assortment packs to be assembled, and the association of each assortment pack with a particular retail store. During optimization, assortment pack builder 16 may minimize, for each cluster of retail stores associated with an assortment pack, one or more of the deviations of contents of the assortment pack from the constraints among the retail stores of the cluster. For instance, assortment pack builder 16 may determine the distribution of the different versions of an item included in the assortment pack so as to minimize the difference between the distribution of the different versions of the item included in the assortment pack and one or more of the maximum number of weeks of supply and minimum number of weeks of supply of each of the retail stores of the cluster.

As another example, assortment pack builder 16 may determine the distribution of the different versions of the item included in an assortment pack based on maximum number of items in the assortment pack. For example, the maximum number of items may be based on a number of items that may physically fit within a representative shipping container (e.g., a box). In some examples, the maximum number of items may be based on a maximum weight capacity of a representative shipping container. Assortment pack builder 16 may determine the distribution of the different versions of the item included in an assortment pack based on the maximum number of items, such as by limiting the number of items included in the assortment pack by the maximum number of items. In certain examples, assortment pack builder 16 may use the maximum number of items to be included in the assortment pack as a constraint during optimization. For example, assortment pack builder 16 may determine the set of assortment packs 12 such that none of assortment packs 12 includes more than the maximum number of items. For instance, the maximum number of items may be one hundred items. As in the example of FIG. 2, assortment pack builder 16 may determine the contents of assortment pack 12A such that the total number of items 18 included in assortment pack 12A is one hundred items or less. That is, in such an example, assortment pack builder 16 may determine distribution 17 such that the sum of the number of items 18A, 18B, and 18C is less than or equal to one hundred items. Assortment pack builder 16 may determine the contents of each of assortment packs 12 such that none of assortment packs 12 includes more than the maximum number of items. Similarly, when changing the distributions of items 18 included in one or more of assortment packs 12 based on forecasted sales of the items among the cluster of retail stores with which the assortment pack has been associated, assortment pack builder 16 may change the distributions such that none of assortment packs 12 includes more than the maximum number of items. As such, assortment pack builder 16 may use the maximum number of items as a constraint during optimization.

In some examples, assortment pack builder 16 may not use the maximum number of items to be included in an assortment pack as a constraint during optimization, but may enforce the maximum number of items as a maximum number of items to be included in any one physical package after optimization. As an example, each of assortment packs 12 may be associated with a one respective physical package, such as a box or other container. For instance, assortment pack 12A may be associated with a single box. Assortment pack 12B may be associated with a single box, separate from the box of assortment pack 12A. Similarly, each of assortment packs 12 may be associated with a separate box. A maximum number of items to be included in any one of assortment packs 12, such as one hundred items, may be determined or set based at least in part on physical constraints of the box with which the assortment packs are associated. For instance, a volume of a typical box used to ship the contents of assortment packs 12 may be typically capable of holding one hundred shirts.

In some examples, assortment pack builder 16 may optimize the distribution of items included in each of assortment packs 12 without limiting the number of items 18 included in any one of assortment packs 12. For instance, assortment pack builder 16 may optimize the distributions of items 18 included in assortment pack 12A, and may determine a distribution of items that includes one hundred eighty items 18 (e.g., fifty large shirts 18A, one hundred medium shirts 18B, and thirty small shirts 18C). In such an example, assortment pack builder 16 may enforce the maximum number of items included in any one of assortment packs 12 (e.g., one hundred items), such as by associating assortment pack 12A with multiple physical packages such that the number of items 18 included in each of the multiple physical packages is less than the maximum number of items (e.g., one hundred eighty items in this example). For in this example, assortment pack builder 16 may associate assortment pack 12A with two physical boxes, each of which includes one hundred of items 18 or less, such as one physical package that includes one hundred of items 18 and another physical package that includes eighty of items 18, or one physical package that includes ninety of items 18 and another physical package that includes ninety of items 18, etc. As such, assortment pack builder 16 may determine an optimized set of assortment packs 12 and associations with retail stores 14 without using the maximum number of items included in the assortment pack as a constraint when determining the distributions included in each assortment pack, but may enforce the physical constraint after determining a set of assortment packs.

As another example, assortment pack builder 16 may determine the distribution of the different versions of the item included in an assortment pack based on a maximum number of assortment packs. For instance, it may be that each of retail stores 20 forecasts a different distribution of sales of items 18. As such, one possible solution may be to assemble a different assortment pack for each of retail stores 14, the distribution of items of each of the assortment packs based at least in part on forecasted sales of items 18 at each of retail stores 14. However, in certain examples, it may be impractical to physically assemble and deliver a number of assortment packs that exceeds a threshold value. For instance, as discussed above, it may not be cost-effective to assemble more than a threshold number of assortment packs (e.g., more than twenty assortment packs). As such, assortment pack builder 16 may, in certain examples, determine the distribution of the different versions of the item included in an assortment pack based on a maximum number of assortment packs. For instance, when the number of retail stores 14 is greater than the maximum number of assortment packs 12, assortment pack builder 16 may determine the set of assortment packs 12 including no more than the maximum number of assortment packs.

In certain examples, assortment pack builder 16 may determine the distribution of items included in an assortment pack based on a cost of overstocking the items and a cost of understocking the items. Overstocking an item may be considered including a quantity of the item in an assortment pack that exceeds a number of forecasted sales of the item at a retail store. A cost of overstocking an item, for example, may be based on a monetary cost that results from a failure to sell the item within the forecasted period of time. Similarly, understocking an item may be considered including a quantity of the item in an assortment pack that is less than a number of forecasted sales of the item at a retail store. A cost of understocking an item, for example, may be based on a lost opportunity to generate a predicted monetary gain from a sale of an item.

As one example, assortment pack builder 16 may compare a cost of overstocking an item to a cost of understocking an item, and may determine a distribution of different versions of the item included in an assortment pack based on the comparison. For instance, assortment pack builder 16 may determine that an average forecasted sales of large shirt 18A among retail stores 14A-14D of cluster 20A includes a fractional value, such as a twenty and one-half shirts. In such an example, assortment pack builder 16 may determine the number of large shirts 18A included in assortment pack 12A based on a comparison of a cost of overstocking large shirt 18A and a cost of understocking large shirt 18A at one or more of retail stores 14. That is, in this example, when the cost of overstocking large shirts 18A exceeds the cost of understocking large shirts 18A, assortment pack builder 16 may understock large shirts 18A, thereby determining the number of large shirts 18A included in assortment pack 12A as twenty shirts. Similarly, in this example, when the cost of understocking large shirts 18A exceeds the cost of overstocking large shirts 18A, assortment pack builder 16 may overstock large shirts 18A, thereby determining the number of large shirts 18A included in assortment pack 12A as twenty-one shirts.

In certain examples, assortment pack builder 16 may continue to associate each of retail stores 14 with one of assortment packs 12 and change the distribution of the different versions of the item included in the assortment packs in an iterative manner. For instance, as in the example of FIG. 2, after changing distribution 17 of assortment pack 12A based on forecasted sales of items 18 at retail stores 14A-14D of cluster 20A to determine a second set of the plurality of assortment packs 12, assortment pack builder 16 may re-associate each of retail stores 14 with one of the second set of assortment packs 12 to determine a second set of clusters of retail stores. That is, for each of retail stores 14, assortment pack builder 16 may associate the retail store with one of the second set of assortment packs 12 that includes one or more modified assortment packs. Assortment pack builder 16 may change the distribution of items 18 included in at least one of the second set of assortment packs based on the forecasted sales of items 18 at the plurality of retail stores of the second set of clusters with which the at least one assortment pack has been associated. In such a way, assortment pack builder 16 may further optimize the number of items 18 included in each of assortment packs 12, thereby possibly helping to further reduce the number of overstocked and understocked items and associated costs at each of the retail stores.

Assortment pack builder 16 may, in such examples, iteratively cluster the retail stores with an assortment pack and change the distribution of items included in the assortment packs until a stopping condition is satisfied. For example, assortment pack builder 16 may determine that the stopping condition is satisfied when, for each of assortment packs 12, the distribution of the different versions of the item (e.g., distribution 17 of items 18) has been changed a threshold number of times (e.g., once, twice, five time, or other numbers of times). For instance, the number of assortment packs 12 included in each iteration may remain constant, and assortment pack builder 16 may determine that the stopping condition is satisfied when the distribution of the different versions of the items included in each of assortment packs 12 has been changed a threshold number of times. In certain examples, assortment pack builder 16 may determine that the stopping condition is satisfied when assortment pack builder 16 has iteratively clustered the retail stores and changed the contents of at least one assortment pack a threshold number of times (e.g., once, three times, etc.)

In some examples, assortment pack builder 16 may determine that the stopping condition is satisfied when, for each of assortment packs 12, a difference between the distribution of the different versions of the items (e.g., distribution 17 of items 18) and a distribution of the forecasted sales of the different versions of the item at each retail store of the cluster of retail stores with which the assortment pack is associated is less than a threshold value. For instance, assortment pack builder 16 may determine an average difference between distribution 17 and a distribution of forecasted sales of items 18 at each of retail stores 14A-14D included in cluster 20A. Assortment pack builder 16 may, in such an example, compare the average distribution difference to a threshold value (e.g., one item, five items, thirty items, and the like). Assortment pack builder 16 may determine that the stopping condition is satisfied when, for each of assortment packs 12, the average distribution difference between the assortment pack and the retail stores included in the cluster of retail stores with which the assortment pack is associated is less than the threshold value.

Assortment pack builder 16 may optimize the contents of each of assortment packs 12 and the associations between each of retail stores 14 and assortment packs 12 (e.g., clusters 20) using one or more of the constraints described above in combination using an optimization algorithm, such as a K-Median optimization algorithm or other similar optimization algorithm. For instance, using such an optimization algorithm, assortment pack builder 16 may use one or more of a forecasted sales of items 18 at each of retail stores 14, a minimum number of each of items 18 to be included in an assortment pack (e.g., a presentation minimum), a maximum number of items 18 to be included in an assortment pack, a maximum weeks of forecasted supply of an item at a retail store to be included in an assortment pack, and a minimum weeks of forecasted supply of an item at a retail store to be included in an assortment pack in combination to determine an optimized set of assortment packs 12 and clusters 20. In addition, assortment pack builder 16 may determine multiple such optimized sets (e.g., one, two, three, five, ten, or more optimized sets of assortment packs and clusters) by performing multiple optimizations from different starting conditions either synchronously or asynchronously. As such, assortment pack builder 16 may select, from the set of multiple solutions, a most optimal set of assortment packs and clusters as among the multiple sets of assortment packs and clusters determined from multiple starting conditions.

As an example, assortment pack builder 16 may determine an initial set of starting conditions as ten assortment packs 12, each including a different distribution of items 18. Assortment pack builder 16 may associate each of retail stores 14 with one of the ten assortment packs 12 so as to group retail stores 14 into a plurality of clusters 20. Assortment pack builder 16 may change the distribution of one or more of the ten assortment packs 12 based on the forecasted sales of each of the retail stores with which the assortment pack has been associated (e.g., a cluster) and one or more other constraints, such as a minimum weeks of supply of items 18 at each of the retail stores of the cluster, a maximum number of items to be included in any one of assortment packs 12, and the like. Assortment pack builder 16 may use an optimization algorithm, such as a K-Median optimization algorithm, to determine the associations and to change the distribution of items 18 in one or more of the ten assortment packs 12 based on the combination of the forecasted sales and the applied constraints. Using the optimization algorithm, assortment pack builder 16 may iteratively cluster the retail stores with an assortment pack and change the distribution of items 18 in one or more of the ten assortment packs 12 based on the forecasted sales of items 18 at each retail store of the cluster and the applied constraints until a stopping condition, such as a threshold number of iterations is satisfied.

In this example, assortment pack builder 16 may determine another set of assortment packs 12 and clusters 20 by iteratively clustering and re-distributing beginning from a different set of initial conditions. For instance, assortment pack builder 16 may determine a different initial set of starting conditions as twenty assortment packs 12 (as opposed to the ten assortment packs of the first optimization in this example), each including a different distribution of items 18. Assortment pack builder 16 may use an optimization algorithm (e.g., a K-Median optimization algorithm) to iteratively cluster and re-distribute items 18 among the twenty assortment packs to determine an optimized set of the twenty assortment packs 12 and associated clusters 20. In certain examples, assortment pack builder 16 may perform more, e.g., more than two such optimizations synchronously or asynchronously, each beginning from a different set of initial conditions (e.g., a different number of assortment packs, a different distribution of items 18 of an initial set of assortment packs, etc.)

Assortment pack builder 16 may compare the multiple sets of assortment packs and associated store clusters determined from the multiple different starting conditions, and may select one of the sets of assortment packs. For instance, as in the above examples, assortment pack builder 16 may determine a first set of assortment packs 12 beginning from a first set of initial conditions (e.g., a first set often assortment packs 12, each including a different distribution of items 18). Assortment pack builder 16 may determine a second set of assortment packs 12 beginning from a second set of initial conditions (e.g., a second set of twenty assortment packs 12, each including a different distribution of items 18).

As one example, assortment pack builder 16 may compare the first and second sets of assortment packs 12, such as by comparing differences of the distributions of items 18 included in each of the sets of assortment packs 12 with the forecasted sales of items 18 at each of the clusters of retail stores with which the assortment packs have been associated. For instance, for each assortment pack of the first set of assortment packs 12 (e.g., the set of assortment packs 12 determined from the first set of initial conditions), assortment pack builder 16 may determine a difference between the distribution of the different versions of items 18 included in the assortment pack and a distribution of the forecasted sales of the different versions of items 18 at each retail store of the cluster of retail stores with which the assortment pack has been associated. As such, assortment pack builder 16 may determine a first plurality of distribution differences.

Similarly, for each assortment pack of the second set of assortment packs 12 (e.g., the set of assortment packs 12 determined from the second set of initial conditions), assortment pack builder 16 may determine a difference between the distribution of the different versions of items 18 included in the assortment pack and a distribution of the forecasted sales of the different versions of items 18 at each retail store of the cluster of retail stores with which the assortment pack has been associated. As such, assortment pack builder 16 may determine a second plurality of distribution differences.

Assortment pack builder 16 may compare the first plurality of distribution differences and the second plurality of distribution differences, and may select one of the first set of assortment packs 12 and the second set of assortment packs 12 based on the comparison. For example, assortment pack builder 16 may select one of the first and second sets of assortment packs 12 based on minimizing the plurality of distribution differences associated with the set of assortment packs. For instance, assortment pack builder 16 may select the set of assortment packs 12 associated with the least average plurality of distribution differences.

As one example, assortment pack builder 16 may determine an average of the distribution differences of the first plurality of distribution differences associated with the first set of assortment packs 12 as a first average distribution difference. Similarly, assortment pack builder 16 may determine an average of the distribution differences of the second plurality of distribution differences associated with the second set of assortment packs 12 as a second average distribution difference. Assortment pack builder 16 may compare the first average distribution difference and the second average distribution difference, and may select the set of assortment packs 12 associated with the distribution difference that has the smallest magnitude.

In some examples, a set of assortment packs and associated clusters of retail stores may result in one or more assortment packs being associated with a relatively small number of retail stores. As one example, an optimization may result in plurality of clusters of retail stores 20, each cluster including an average of forty retail stores 14. However, in such an example, an optimization may result in one or more clusters 20 that include significantly fewer retail stores 14, such as five retail stores 14. A retail chain, vendor, or both may determine that it is not cost effective to assemble a unique assortment pack for delivery to such a cluster of retail stores that includes fewer than a threshold number of stores. In some examples, the threshold number of stores may be determined based on a cost to assemble an assortment pack (e.g., based on decreased efficiency of the vendor to assemble the additional assortment pack) versus the cost benefit of the additional assortment pack (e.g., an estimated cost reduction and/or increase in revenue based on minimizing possible overstocked and understocked items). As such, the threshold number of stores may vary depending upon factors such as the number of individual retail stores 14 in the retail chain, the number of different assortment packs to be delivered to individual retail stores of the retail chain, a sales price of the item included in the assortment pack, etc.)

When the number of retail stores included in a cluster of retail stores is less than a threshold value (e.g., a value determined by one or more of the retail chain and vendor), assortment pack builder 16 may associate each retail store of the cluster with an assortment pack associated with a different cluster, thereby eliminating the assortment pack of the cluster that includes fewer than the threshold number of retail stores. Assortment pack builder 16 may reassign each retail store of the cluster based on a closeness of fit between the distribution of forecasted items 18 at the retail store and the distribution of items 18 included in an assortment pack. Similarly, assortment pack builder 16 may reassign each retail store of the cluster based on one or more constraints, such as a minimum weeks of supply of items 18, a maximum weeks of supply of items 18, and other similar constraints.

In certain examples, responsive to determining that the stopping condition is satisfied, assortment pack builder 16 may output an indication of the selected set of the plurality of assortment packs (e.g., a set of assortment packs 12 selected from two, three, five, ten, or more optimizations). In addition, assortment pack builder 16 may output an indication of the associations between the plurality of retail stores (e.g., retail stores 14) and the selected set of the plurality of assortment packs. For instance, for each of retail stores 14, assortment pack builder 16 may output an indication of the assortment pack with which the retail store is associated. Examples of the indication include, but are not limited to, graphical indications output at a display device operatively coupled to computing device 10, reports (e.g., one or more spreadsheets, text files, or other types of documents or files), or one or more other types of indications capable of communicating the contents of each assortment pack and the associations between each retail store and assortment pack to a user or other computing device.

As such, techniques described herein may enable computing device 10 to determine a plurality of assortment packs including a plurality of different versions of an item to be sold at a plurality of retail stores. The techniques may help to reduce the costs associated with delivery of items from a vendor to a retail store, as well as the costs associated with understocking or overstocking the items, reduction of one or both of which may, in turn, improve sales and profit of the retailer.

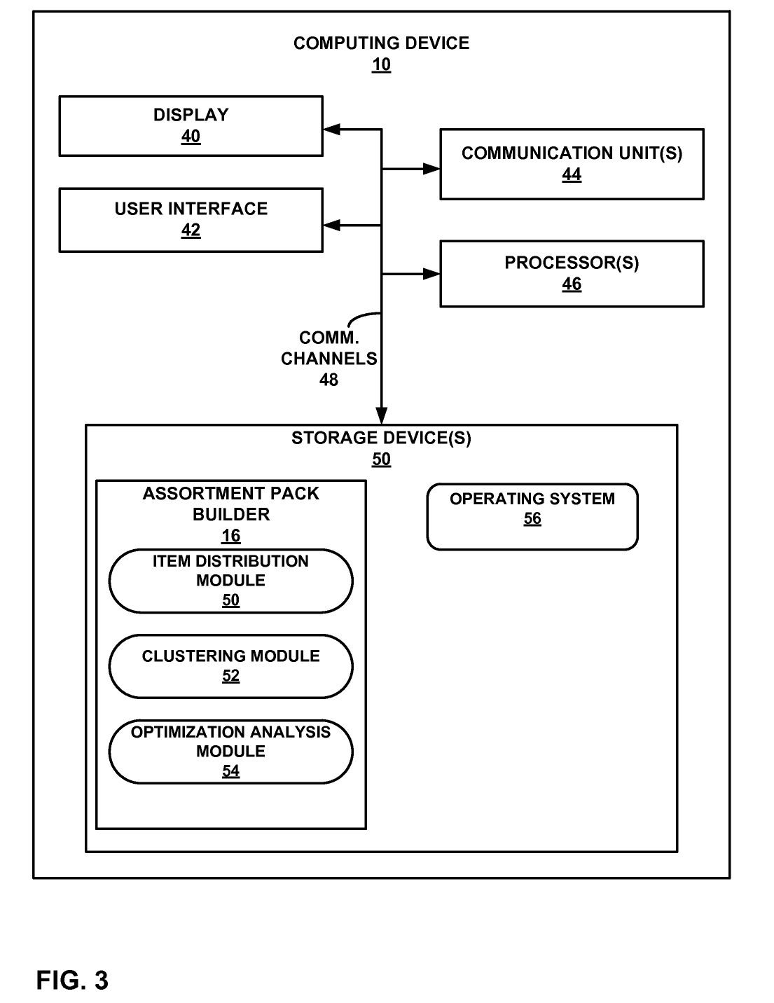

FIG. 3 is a block diagram illustrating further details of one example of computing device 10 as shown in FIG. 2. FIG. 3 illustrates only one particular example of computing device 10, and many other examples of computing device 10 may be used in other instances. In addition, as discussed above, although discussed with respect to one computing device 10, one or more components and functions of computing device 10 may be distributed among multiple computing devices 10.

As shown in the specific example of FIG. 3, computing device 10 includes display 40, user interface 42, one or more communication units 44, one or more processors 46, and one or more storage devices 50. As illustrated, computing device 10 further includes assortment pack builder 16 and operating system 56. Assortment pack builder 16 includes item distribution module 50, clustering module 52, and optimization analysis module 54. Each of components 40, 42, 44, 46, and 50 may be interconnected (physically, communicatively, and/or operatively) for inter-component communications. In some examples, communication channels 48 may include a system bus, network connection, inter-process communication data structure, or any other channel for communicating data. As one example in FIG. 3, components 40, 42, 44, 46, and 50 may be coupled by one or more communication channels 4. Assortment pack builder 16, item distribution module 50, clustering module 52, optimization analysis module 54, and operating system 56 may also communicate information with one another as well as with other components of computing device 10.

Display 40 may be a liquid crystal display (LCD), e-ink, organic light emitting diode (OLED), or other display. Display 40 may present the content of computing device 10 to a user. For example, display 40 may display the output of assortment pack builder 16 executed on one or more processors 46 of computing device 10, confirmation messages, indications, or other functions that may need to be presented to a user. In some examples, display 40 may provide some or all of the functionality of a user interface of computing device 10. For instance, display 40 may be a touch-sensitive and/or presence-sensitive display that can display a graphical user interface (GUI) and detect input from a user in the form of user input gestures using capacitive or inductive detection at or near the presence-sensitive display.

User interface 42 may allow a user of computing device 10 to interact with computing device 10. Examples of user interface 42 may include, but are not limited to, a keypad embedded on computing device 10, a keyboard, a mouse, a roller ball, buttons, or other devices that allow a user to interact with computing device 10. In some examples, computing device 10 may not include user interface 42, and the user may interact with computing device 10 with display 40 (e.g., by providing various user gestures). In some examples, the user may interact with computing device 10 with user interface 42 or display 40.

Computing device 10, in some examples, also includes one or more communication units 44. Computing device 10, in one example, utilizes one or more communication units 44 to communicate with external devices via one or more networks, such as one or more wireless networks, one or more cellular networks, or other types of networks. One or more communication units 44 may be a network interface card, such as an Ethernet card, an optical transceiver, a radio frequency transceiver, or any other type of device that can send and receive information. Other examples of such network interfaces may include Bluetooth, 3G and WiFi radio computing devices as well as Universal Serial Bus (USB).

One or more processors 46, in one example, are configured to implement functionality and/or process instructions for execution within computing device 10. For example, one or more processors 46 may be capable of processing instructions stored at one or more storage devices 50. Examples of one or more processors 46 may include any one or more of a microprocessor, a controller, a digital signal processor (DSP), an application specific integrated circuit (ASIC), a field-programmable gate array (FPGA), or equivalent discrete or integrated logic circuitry.

One or more storage devices 50 may be configured to store information within computing device 10 during operation. One or more storage devices 50, in some examples, may be described as a computer-readable storage medium. In some examples, one or more storage devices 50 may be a temporary memory, meaning that a primary purpose of one or more storage devices 50 is not long-term storage. One or more storage devices 50 may, in some examples, be described as a volatile memory, meaning that one or more storage devices 50 do not maintain stored contents when the computer is turned off. Examples of volatile memories include random access memories (RAM), dynamic random access memories (DRAM), static random access memories (SRAM), and other forms of volatile memories known in the art. In some examples, one or more storage devices 50 may be used to store program instructions for execution by one or more processors 46. One or more storage devices 50, for example, may be used by software or applications running on computing device 10 (e.g., assortment pack builder 16) to temporarily store information during program execution.

One or more storage devices 50, in some examples, also include one or more computer-readable storage media. One or more storage devices 50 may be configured to store larger amounts of information than volatile memory. One or more storage devices 50 may further be configured for long-term storage of information. In some examples, one or more storage devices 50 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

As illustrated in FIG. 3, computing device 10 may include assortment pack builder 16. Assortment pack builder 16 may include item distribution module 50, clustering module 52, and optimization analysis module 54. Although shown as separate components in FIG. 3, in some examples, one or more of assortment pack builder 16, item distribution module 50, clustering module 52, and optimization analysis module 54 may be part of the same module. In some examples, one or more of assortment pack builder 16, item distribution module 50, clustering module 52, optimization analysis module 54, and one or more processors 46 may be formed in a common hardware unit. In some instances, one or more of assortment pack builder 16, item distribution module 50, clustering module 52, and optimization analysis module 54 may be software and/or firmware units that are executed on one or more processors 46. In general, the modules of assortment pack builder 16 are presented separately for ease of description and illustration. However, such illustration and description should not be construed to imply that these modules of assortment pack builder 16 are necessarily separately implemented, but can be in some examples.

Computing device 10 may include operating system 56. Operating system 56, in some examples, controls the operation of components of computing device 10. For example, operating system 56, in one example, facilitates the communication of assortment pack builder 16 with one or more processors 46, display 40, user interface 42, and one or more communication units 44.

Computing device 10 may include additional components not shown in FIG. 3 for clarity. For example, computing device 10 may include a battery to provide power to the components of computing device 10. Similarly, the components of computing device 10 may not be necessary in every example of computing device 10. For instance, in certain examples computing device 10 may not include display 40.

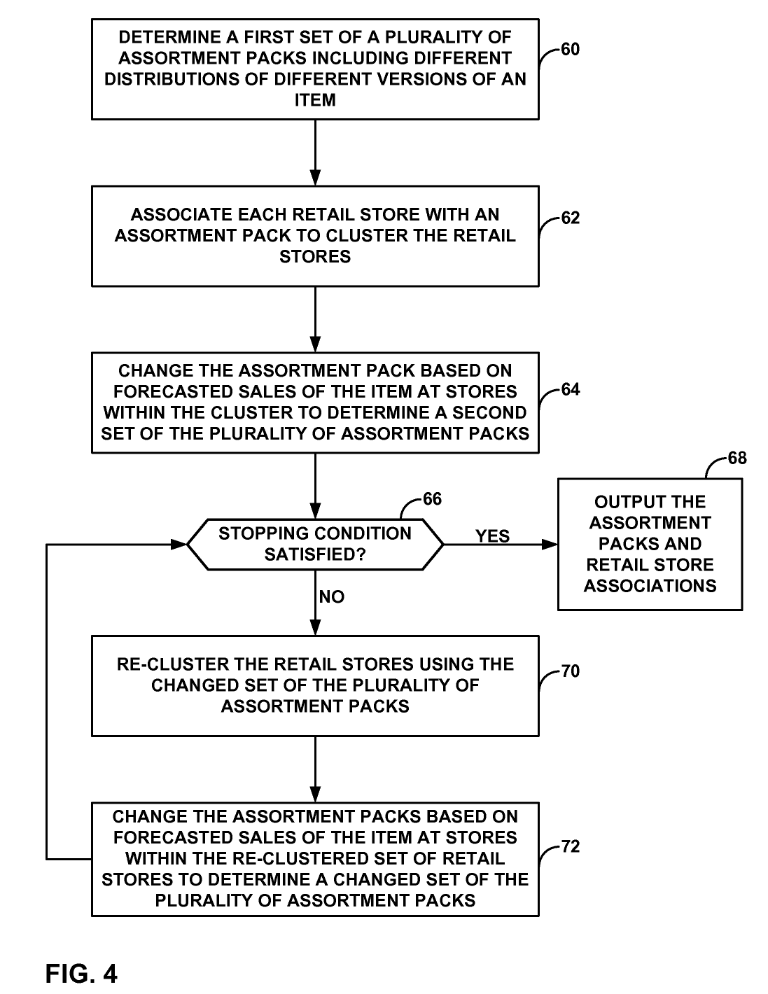

FIG. 4 is a flow diagram illustrating example operations of a computing device to determine a plurality of assortment packs and, for each of a plurality of retail stores, associate the retail store with one of the plurality of assortment packs. The example illustrated in FIG. 4 is only one example operation, and other implementations may include more or fewer aspects than those depicted in FIG. 4. For purposes of illustrations only, the example operations are described below within the context of computing device 10.

Item distribution module 50, executing on one or more processors 46, may determine a first set of a plurality of assortment packs that include a plurality of different versions of an item to be sold at a plurality of retail stores (60). The different versions of the item may include at least one of a different size, color and style of the item. Item distribution module 50 may determine the first set of the plurality of assortment packs based at least in part on forecasted sales of the item at each of the plurality of retail stores. Each of the plurality of assortment packs of the first set of assortment packs may include a different distribution of the different versions of the item. A number of the plurality of retail stores may be larger than a number of the plurality of assortment packs of the first set of the plurality of assortment packs. In some examples, item distribution module 50 may determine, for each of the plurality of assortment packs, the distribution of the different versions of the item based on at least one of a minimum number of each of the different versions of the item, a maximum number of each of the different versions of the item, a forecasted sales of each of the different versions of the item for a configurable period of time, a maximum number of items in the assortment pack, and a maximum number of assortment packs. The different versions of the item may, in certain examples, include at least one of a different size, color, and style of the item.

For each retail store of the plurality of retail stores, clustering module 52, executing on one or more processors 46, may associate the retail store with an assortment pack of the first set of the plurality of assortment packs based at least in part on the forecasted sales of the item at the retail store, such that the plurality of retail stores is grouped into a plurality of clusters of retail stores (62). Each cluster of retail stores may include a plurality of retail stores that have each been associated with a same one of the plurality of assortment packs.

Item distribution module 50 may change the distribution of the different versions of the item of at least one of the plurality of assortment packs based at least in part on the forecasted sales of the item at each retail store of the cluster of retail stores with which the at least one of the plurality of assortment packs has been associated so as to determine a second set of the plurality of assortment packs (64). In some examples, item distribution module 50 may determine, for each of the different versions of the item included in the at least one of the plurality of assortment packs, a difference between a number of the version of the item included in the at least one of the plurality of assortment packs and a forecasted sales of the version of the item at each retail store of the cluster of retail stores with which the at least one of the plurality of assortment packs has been associated so as to determine a plurality of differences of the number of the version of the item. In certain examples, item distribution module 50 may change the distribution of the different versions of the item of the at least one of the plurality of assortment packs based at least in part on minimizing each difference of the plurality of differences of the number of the version of the item. In some examples, item distribution module 50 may change the distribution of the different versions of the item based at least in part on a cost of overstocking the item and a cost of understocking the item.

Optimization analysis module 54 may determine whether a stopping condition is satisfied (66). For example, optimization analysis module 54 may determine, for each assortment pack of the second set of the plurality of assortment packs, a difference between the distribution of the different versions of the item and a distribution of the forecasted sales of the different versions of the item at each retail store of the cluster of retail stores with which the assortment pack has been associated so as to determine a plurality of distribution differences. In such an example, optimization analysis module 54 may determine that the stopping condition is satisfied when each of the differences of the plurality of distribution differences is less than a threshold value. As another example, optimization analysis module 54 may determine that the stopping condition is satisfied when, for each assortment pack of the second set of the plurality of assortment packs, the distribution of the different versions of the item of the respective assortment pack has been changed a threshold number of times.

When optimization analysis module 54 determines that the stopping condition is satisfied (“YES” branch of 66), optimization analysis module 54 may output an indication of the set of the plurality of assortment packs. In addition, optimization analysis module 54 may output, for each retail store of the plurality of retail stores, an indication of the assortment pack of the set of the plurality of assortment packs with which the retail store has been associated.

When optimization analysis module 54 determines that the stopping condition is not satisfied (“NO” branch of 66), clustering module 52 may re-cluster the retail stores using the changed set of the plurality of assortment packs (70). For example, for each retail store of the plurality of retail stores, clustering module 52 may associate the retail store with an assortment pack of the changed set of the plurality of assortment packs based at least in part on the forecasted sales of the item at each retail store such that the plurality of retail stores is grouped into a changed set of a plurality of clusters of retail stores. Distribution module 50 may change the distribution of the different versions of the item of at least one of the plurality of assortment packs based at least in part on the forecasted sales of the item at each retail store of the cluster of retail stores of the changed set of the plurality of clusters of retail stores with which the at least one of the plurality of assortment packs has been associated so as to determine a changed set of the plurality of assortment packs (72). Optimization analysis module 54 may determine whether a stopping condition has been satisfied (66). In general, computing device 10 may perform operations 66, 70, and 72 in an iterative manner until the optimization analysis module 54 determines that a stopping condition is satisfied.

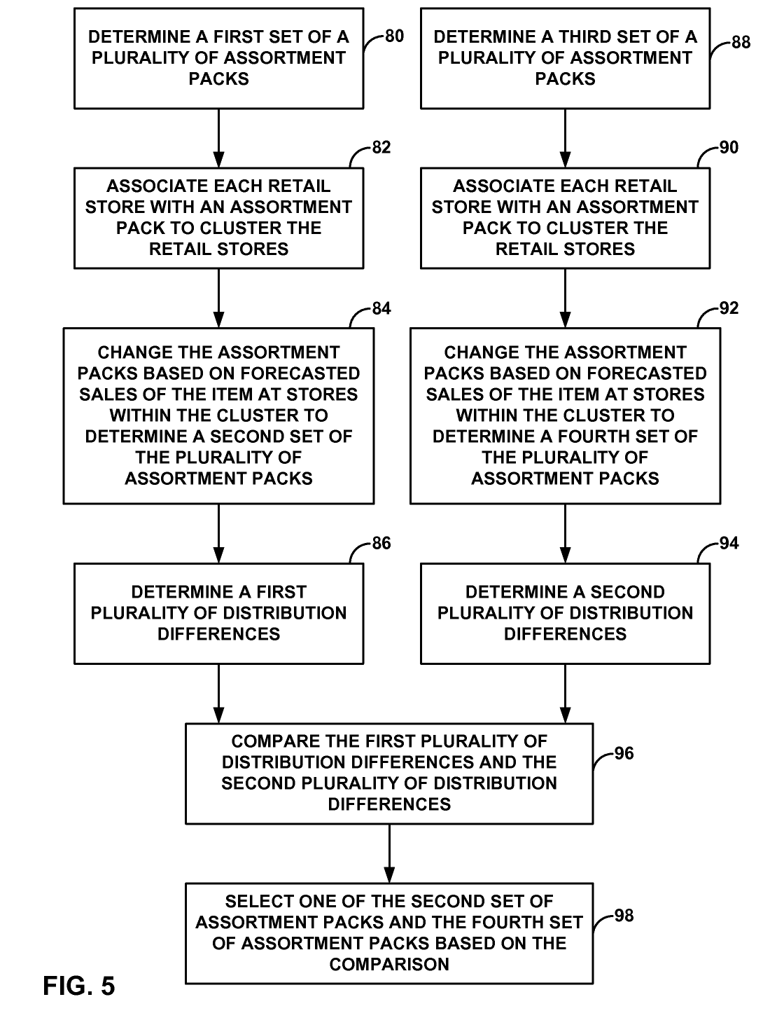

FIG. 5 is a flowchart illustrating example operations of a computing device to determine a plurality of assortment packs and, for each of a plurality of retail stores, associate the retail store with one of the plurality of assortment packs. The example illustrated in FIG. 5 is only one example operation, and other implementations may include more or fewer aspects than those depicted in FIG. 5. For purposes of illustrations only, the example operations are described below within the context of computing device 10.

In general, the operations of FIG. 5 may be similar in many respects to the operations of FIG. 4. For example, operations 80-84 and 88-92 of FIG. 5 are substantially similar to operations 60-64 of FIG. 4. In addition, operations 80-84 and 88-92 of FIG. 5 may each be performed in an iterative manner that is substantially similar to operations 66, 70, and 72 of FIG. 4. In general, the example operations of FIG. 5 illustrate one example technique for determining two separate sets of assortment packs starting from two separate sets of initial conditions. Each of the two resulting sets of assortment packs may, in some examples, be compared to the forecasted sales of the items at the plurality of retail stores to determine a closeness of fit between each set of assortment packs and the forecasted sales. In certain examples, the resulting set of assortment packs that most closely fits the distribution of forecasted sales of the items at the plurality of retail stores may be selected.

However, it should be understood that the example operations of FIG. 5 are not limited to two separate sets of initial conditions. For instance, the operations may be performed with three, four, five, ten, or more sets of initial conditions. In such examples, a resulting set of assortment packs that most closely fits the distribution of forecasted sales of the items at the plurality of retail stores and/or most closely adheres to one or more constraints of the optimization algorithm (e.g., constraints such as a maximum number of items included in any one assortment pack, a minimum weeks of forecasted supply of an item at one or more retail stores, and the like) may be selected from the resulting sets of assortment packs (e.g., three, four, five, ten, or more resulting sets of assortment packs). In addition, it should be understood that operations 80-86, operations 88-94, and any similar additional operations may be performed in parallel, in series, synchronously, or asynchronously, such that any one or more of the operations may be performed at the same time or at different times and may be distributed among multiple computing devices 10.

Item distribution module 50, executing on one or more processors 46, may determine a first set of a plurality of assortment packs that include a plurality of different versions of an item to be sold at a plurality of retail stores (80). Item distribution module 50 may determine the first set of the plurality of assortment packs based at least in part on forecasted sales of the item at each of the plurality of retail stores. Each of the plurality of assortment packs of the first set of assortment packs may include a different distribution of the different versions of the item. A number of the plurality of retail stores may be larger than a number of the plurality of assortment packs of the first set of the plurality of assortment packs.

For each retail store of the plurality of retail stores, clustering module 52, executing on one or more processors 46, may associate the retail store with an assortment pack of the first set of the plurality of assortment packs based at least in part on the forecasted sales of the item at the retail store, such that the plurality of retail stores is grouped into a first plurality of clusters of retail stores (82). Item distribution module 50 may change the distribution of the different versions of the item of at least one of the first set of the plurality of assortment packs based at least in part on the forecasted sales of the item at each retail store of the first plurality of clusters of retail stores with which the at least one of the plurality of assortment packs of the first set of the plurality of assortment packs has been associated so as to determine a second set of the plurality of assortment packs (84).

In certain examples, determining the first set the plurality of assortment packs may include determining the first set of the plurality of assortment packs based at least in part on a first maximum number of items included in each assortment pack of the first set of the plurality of assortment packs such that a number of a plurality of items included in each assortment pack of the first set of the plurality of assortment packs is less than the first maximum number of items. In some examples, changing the distribution of the different versions of the item of at least one of the plurality of assortment packs of the first set of the plurality of assortment packs may include changing the distribution of the different versions of the item of the at least one of the plurality of assortment packs of the first set of the plurality of assortment packs based at least in part on the first maximum number of items such that a number of a plurality of items included in each assortment pack of the second set of the plurality of assortment packs is less than the first maximum number of items.

In certain examples, each assortment pack of the first set of the plurality of assortment packs may be associated with one respective physical package (e.g., one respective box). Determining the first set of the plurality of assortment packs may include determining the first set of the plurality of assortment packs without limiting a number of a plurality of items included in each assortment pack of the first set of the plurality of assortment packs. Changing the distribution of the different versions of the item of at least one of the plurality of assortment packs of the first set of the plurality of assortment packs may include changing the distribution of the different versions of the item of the at least one of the plurality of assortment packs of the first set of the plurality of assortment packs without limiting a number of a plurality of items included in each assortment pack of the second set of the plurality of assortment packs. In some examples, for each assortment pack of the second set of the plurality of assortment packs, item distribution module 50 may determine whether the number of the plurality of items included in the respective assortment pack is greater than a first maximum number of items. Responsive to determining that the number of the plurality of items included in the respective assortment pack is greater than the first maximum number of items, item distribution module 50 may associate the respective assortment pack with multiple physical packages such that a number of a plurality of items included in each of the multiple physical packages is less than the first maximum number of items.

Optimization analysis module 54, executing on one or more processors 46, may determine, for each assortment pack of the second set of the plurality of assortment packs, a difference between the distribution of the different versions of the item and a distribution of the forecasted sales of the different versions of the item at each retail store of the cluster of retail stores of the first plurality of clusters of retail stores with which the assortment pack has been associated so as to determine a first plurality of distribution differences (86).

Item distribution module 50, executing on one or more processors 46, may determine a third set of a plurality of assortment packs that include a plurality of different versions of an item to be sold at a plurality of retail stores (88). Item distribution module 50 may determine the third set of the plurality of assortment packs based at least in part on forecasted sales of the item at each of the plurality of retail stores. Each of the plurality of assortment packs of the third set of assortment packs may include a different distribution of the different versions of the item. A number of the plurality of retail stores may be larger than a number of the plurality of assortment packs of the third set of the plurality of assortment packs.

The third set of the plurality of assortment packs may be different than the first set of the plurality of assortment packs. As one example, the third set may include a different number of assortment packs than the first set. As another example, a distribution of the items included in at least one of the assortment packs of the third set may be different than the distribution of the items included in any of the assortment packs of the first set.

For each retail store of the plurality of retail stores, clustering module 52, executing on one or more processors 46, may associate the retail store with an assortment pack of the third set of the plurality of assortment packs based at least in part on the forecasted sales of the item at the retail store, such that the plurality of retail stores is grouped into a second plurality of clusters of retail stores (90). Item distribution module 50 may change the distribution of the different versions of the item of at least one of the third set of the plurality of assortment packs based at least in part on the forecasted sales of the item at each retail store of the second plurality of clusters of retail stores with which the at least one of the plurality of assortment packs of the third set of the plurality of assortment packs has been associated so as to determine a fourth set of the plurality of assortment packs (92).

In certain examples, determining the third set the plurality of assortment packs may include determining the third set of the plurality of assortment packs based at least in part on a second maximum number of items included in each assortment pack of the third set of the plurality of assortment packs such that a number of a plurality of items included in each assortment pack of the third set of the plurality of assortment packs is less than the second maximum number of items. In some examples, changing the distribution of the different versions of the item of at least one of the plurality of assortment packs of the third set of the plurality of assortment packs may include changing the distribution of the different versions of the item of the at least one of the plurality of assortment packs of the third set of the plurality of assortment packs based at least in part on the second maximum number of items such that a number of a plurality of items included in each assortment pack of the fourth set of the plurality of assortment packs is less than the second maximum number of items.

In certain examples, each assortment pack of the third set of the plurality of assortment packs may be associated with one respective physical package (e.g., one respective box). Determining the third set of the plurality of assortment packs may include determining the third set of the plurality of assortment packs without limiting a number of a plurality of items included in each assortment pack of the third set of the plurality of assortment packs. Changing the distribution of the different versions of the item of at least one of the plurality of assortment packs of the third set of the plurality of assortment packs may include changing the distribution of the different versions of the item of the at least one of the plurality of assortment packs of the third set of the plurality of assortment packs without limiting a number of a plurality of items included in each assortment pack of the fourth set of the plurality of assortment packs. In some examples, for each assortment pack of the fourth set of the plurality of assortment packs, item distribution module 50 may determine whether the number of the plurality of items included in the respective assortment pack is greater than a second maximum number of items. Responsive to determining that the number of the plurality of items included in the respective assortment pack is greater than the second maximum number of items, item distribution module 50 may associate the respective assortment pack with multiple physical packages such that a number of a plurality of items included in each of the multiple physical packages is less than the second maximum number of items.

Optimization analysis module 54, executing on one or more processors 46, may determine, for each assortment pack of the fourth set of the plurality of assortment packs, a difference between the distribution of the different versions of the item and a distribution of the forecasted sales of the different versions of the item at each retail store of the cluster of retail stores of the second plurality of clusters of retail stores with which the assortment pack has been associated so as to determine a second plurality of distribution differences (86). Optimization analysis module 54 may compare the first plurality of distribution differences and the second plurality of distribution differences (96).

Optimization analysis module 54 may select one of the second set the plurality of assortment packs and the fourth set of the plurality of assortment packs based on the comparison (98). For example, optimization analysis module 54 may select one of the second and fourth sets of the pluralities of assortment packs based on minimizing the distribution differences of the first and second pluralities of distribution differences. As such, optimization analysis module 54 may select the set of assortment packs that most closely matches the distribution of forecasted sales among the plurality of retail stores.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
determining, with a computing device, a first set of a plurality of assortment packs that include a plurality of different versions of an item to be sold at a plurality of retail stores based at least in part on forecasted sales of the item at each of the plurality of retail stores, wherein each of the plurality of assortment packs of the first set of the plurality of assortment packs includes a different distribution of the different versions of the item;
for each retail store of the plurality of retail stores, associating, with the computing device, the retail store with an assortment pack of the first set of the plurality of assortment packs based at least in part on the forecasted sales of the item at the retail store such that the plurality of retail stores is grouped into a first plurality of clusters of retail stores;
changing, with the computing device, the distribution of the different versions of the item of at least one of the plurality of assortment packs of the first set of the plurality of assortment packs based at least in part on the forecasted sales of the item at each retail store of the cluster of retail stores of the first plurality of clusters of retail stores with which the at least one of the plurality of assortment packs of the first set of the plurality of assortment packs has been associated so as to determine a second set of a plurality of assortment packs;
determining, with the computing device, a third set of a plurality of assortment packs that include a plurality of different versions of the item to be sold at the plurality of retail stores based at least in part on forecasted sales of the item at each of the plurality of retail stores, wherein each of the plurality of assortment packs of the third set of the plurality of assortment packs includes a different distribution of the different versions of the item, and wherein the third set of the plurality of assortment packs is different than the first set of the plurality of assortment packs;
for each retail store of the plurality of retail stores, associating, with the computing device, the retail store with an assortment pack of the third set of the plurality of assortment packs based at least in part on the forecasted sales of the item at the retail store such that the plurality of retail stores is grouped into a second plurality of clusters of retail stores;
changing, with the computing device, the distribution of the different versions of the item of at least one of the plurality of assortment packs of the third set of the plurality of assortment packs based at least in part on the forecasted sales of the item at each retail store of the cluster of retail stores of the second plurality of clusters of retail stores with which the at least one of the plurality of assortment packs of the third set of the plurality of assortment packs has been associated so as to determine a fourth set of a plurality of assortment packs;
comparing, with the computing device, the second set of the plurality of assortment packs and the fourth set of the plurality of assortment packs; and
selecting, with the computing device, one of the second set of the plurality of assortment packs and the fourth set of the plurality of assortment packs based on the comparison.

2. The method of claim 1, further comprising:
for each retail store of the plurality of retail stores, associating, with the computing device, the retail store with an assortment pack of the second set of the plurality of assortment packs based at least in part on the forecasted sales of the item at each retail store such that the plurality of retail stores is grouped into a third plurality of clusters of retail stores;
changing, with the computing device, the distribution of the different versions of the item of at least one of the plurality of assortment packs of the second set of the plurality of assortment packs based at least in part on the forecasted sales of the item at each retail store of the cluster of retail stores of the third plurality of clusters of retail stores with which the at least one of the plurality of assortment packs has been associated so as to determine a fifth set of the plurality of assortment packs;
for each retail store of the plurality of retail stores, associating, with the computing device, the retail store with an assortment pack of the fourth set of the plurality of assortment packs based at least in part on the forecasted sales of the item at each retail store such that the plurality of retail stores is grouped into a fourth plurality of clusters of retail stores; and
changing, with the computing device, the distribution of the different versions of the item of at least one of the plurality of assortment packs of the fourth set of the plurality of assortment packs based at least in part on the forecasted sales of the item at each retail store of the cluster of retail stores of the fourth plurality of clusters of retail stores with which the at least one of the plurality of assortment packs has been associated so as to determine a sixth set of the plurality of assortment packs.

3. The method of claim 2, further comprising:
comparing, with the computing device, the fifth set of the plurality of assortment packs and the sixth set of the plurality of assortment packs; and
selecting, with the computing device, one of the fifth set of the plurality of assortment packs and the sixth set of the plurality of assortment packs based on the comparison.

4. The method of claim 2, further comprising:
determining, with the computing device, that a stopping condition is satisfied; and
responsive to determining that the stopping condition is satisfied, outputting, with the computing device:
an indication of the selected one of the second set of the plurality of assortment packs and the fourth set of the plurality of assortment packs; and
for each retail store of the plurality of retail stores, an indication of the assortment pack of the selected one of the second set of the plurality of assortment packs and the fourth set of the plurality of assortment packs with which the retail store has been associated.

5. The method of claim 4, wherein determining that the stopping condition is satisfied comprises:
determining, for each assortment pack of the second set of the plurality of assortment packs, a difference between the distribution of the different versions of the item and a distribution of the forecasted sales of the different versions of the item at each retail store of the cluster of retail stores of the first plurality of clusters of retail stores with which the assortment pack has been associated so as to determine a first plurality of distribution differences;
determining that each of the distribution differences of the first plurality of distribution differences is less than a threshold value;
determining, for each assortment pack of the fourth set of the plurality of assortment packs, a difference between the distribution of the different versions of the item and a distribution of the forecasted sales of the different versions of the item at each retail store of the cluster of retail stores of the second plurality of clusters of retail stores with which the assortment pack has been associated so as to determine a second plurality of distribution differences; and
determining that each of the distribution differences of the second plurality of distribution differences is less than the threshold value.

6. The method of claim 4, wherein the number of the plurality of assortment packs of the first set of the plurality of assortment packs is the same as a number of the plurality of assortment packs of the second set of the plurality of assortment packs, and wherein the number of the plurality of assortment packs of the third set of the plurality of assortment packs is the same as a number of the plurality of assortment packs of the fourth set of the plurality of assortment packs.

7. The method of claim 6, wherein determining that the stopping condition is satisfied comprises:
determining, for each assortment pack of the second set of the plurality of assortment packs, that the distribution of the different versions of the item of the respective assortment pack of the second set of the plurality of assortment packs has been changed a threshold number of times; and
determining, for each assortment pack of the fourth set of the plurality of assortment packs, that the distribution of the different versions of the item of the respective assortment pack of the fourth set of the plurality of assortment packs has been changed the threshold number of times.

8. The method of claim 1, wherein each cluster of the first plurality of clusters of retail stores comprises a plurality of retail stores that have each been associated with the same assortment pack of the second set of the plurality of assortment packs, and wherein each cluster of the second plurality of clusters of retail stores comprises a plurality of retail stores that have each been associated with the same assortment pack of the fourth set of the plurality of assortment packs.

9. The method of claim 1, further comprising:
determining, with the computing device and for each assortment pack of the second set of the plurality of assortment packs, a difference between the distribution of the different versions of the item and a distribution of the forecasted sales of the different versions of the item at each retail store of the cluster of retail stores of the first plurality of clusters of retail stores with which the assortment pack has been associated so as to determine a first plurality of distribution differences; and
determining, with the computing device and for each assortment pack of the fourth set of the plurality of assortment packs, a difference between the distribution of the different versions of the item and a distribution of the forecasted sales of the different versions of the item at each retail store of the cluster of retail stores of the second plurality of clusters of retail stores with which the assortment pack has been associated so as to determine a second plurality of distribution differences,
wherein comparing the second set of the plurality of assortment packs and the fourth set of the plurality of assortment packs comprises comparing the first plurality of distribution differences and the second plurality of distribution differences.

10. The method of claim 9,
wherein comparing the first plurality of distribution differences and the second plurality of distribution differences comprises:
determining a first average distribution difference of the first plurality of distribution differences;
determining a second average distribution difference of the second plurality of distribution differences; and
comparing the first average distribution difference and the second average distribution difference to determine a least average distribution difference, and
wherein selecting one of the second set of the plurality of assortment packs and the fourth set of the plurality of assortment packs comprises selecting the one of the second set of the plurality of assortment packs and the fourth set of the plurality of assortment packs that is associated with the least average distribution difference.

11. The method of claim 1,
wherein determining the first set of the plurality of assortment packs comprises determining, for each of the plurality of assortment packs of the first set of the plurality of assortment packs, the distribution of the different versions of the item based on at least one of a first minimum number of each of the different versions of the item, a first maximum number of each of the different versions of the item, a forecasted sales of each of the different versions of the item for a configurable period of time, a first maximum number of items in the assortment pack, and a first maximum number of assortment packs, and
wherein determining the third set of the plurality of assortment packs comprises determining, for each of the plurality of assortment packs of the third set of the plurality of assortment packs, the distribution of the different versions of the item based on at least one of a second minimum number of each of the different versions of the item, a second maximum number of each of the different versions of the item, a forecasted sales of each of the different versions of the item for a configurable period of time, a second maximum number of items in the assortment pack, and a second maximum number of assortment packs.

12. The method of claim 1, wherein the different versions of the item comprise at least one of a different size, color, and style of the item.

13. The method of claim 1,
wherein changing the distribution of the different versions of the item of at least one of the plurality of assortment packs of the first set of the plurality of assortment packs comprises:
determining, for each of the different versions of the item included in the at least one of the plurality of assortment packs of the first set of the plurality of assortment packs, a difference between a number of the version of the item included in the at least one of the plurality of assortment packs of the first set of the plurality of assortment packs and a forecasted sales of the version of the item at each retail store of the first plurality of clusters of retail stores with which the at least one of the plurality of assortment packs of the first set of the plurality of assortment packs has been associated so as to determine a first plurality of differences of the number of the version of the item; and
changing the distribution of the different versions of the item of the at least one of the plurality of assortment packs of the first set of the plurality of assortment packs based at least in part on minimizing each difference of the first plurality of differences of the number of the version of the item; and
wherein changing the distribution of the different versions of the item of at least one of the plurality of assortment packs of the third set of the plurality of assortment packs comprises:
determining, for each of the different versions of the item included in the at least one of the plurality of assortment packs of the third set of the plurality of assortment packs, a difference between a number of the version of the item included in the at least one of the plurality of assortment packs of the first set of the plurality of assortment packs and a forecasted sales of the version of the item at each retail store of the second plurality of clusters of retail stores with which the at least one of the plurality of assortment packs of the third set of the plurality of assortment packs has been associated so as to determine a second plurality of differences of the number of the version of the item; and
changing the distribution of the different versions of the item of the at least one of the plurality of assortment packs of the third set of the plurality of assortment packs based at least in part on minimizing each difference of the second plurality of differences of the number of the version of the item.

14. The method of claim 1, wherein the third set of the plurality of assortment packs is different than the first set of the plurality of assortment packs with respect to at least one of:
the number of the plurality of assortment packs of the first set of the plurality of assortment packs and the number of the plurality of assortment packs of the third set of the plurality of assortment packs; and
the distribution of the different versions of the item included in the first set of the plurality of assortment packs and the distribution of the different versions of the item included in the third set of the plurality of assortment packs.

15. The method of claim 1,
wherein determining the first set of the plurality of assortment packs comprises determining the first set of the plurality of assortment packs based at least in part on a first maximum number of items included in each assortment pack of the first set of the plurality of assortment packs such that a number of a plurality of items included in each assortment pack of the first set of the plurality of assortment packs is less than the first maximum number of items,
wherein changing the distribution of the different versions of the item of at least one of the plurality of assortment packs of the first set of the plurality of assortment packs comprises changing the distribution of the different versions of the item of the at least one of the plurality of assortment packs of the first set of the plurality of assortment packs based at least in part on the first maximum number of items such that a number of a plurality of items included in each assortment pack of the second set of the plurality of assortment packs is less than the first maximum number of items,
wherein determining the third set of the plurality of assortment packs comprises determining the third set of the plurality of assortment packs based at least in part on a second maximum number of items included in each assortment pack of the third set of the plurality of assortment packs such that a number of a plurality of items included in each assortment pack of the third set of the plurality of assortment packs is less than the second maximum number of items, and
wherein changing the distribution of the different versions of the item of at least one of the plurality of assortment packs of the third set of the plurality of assortment packs comprises changing the distribution of the different versions of the item of the at least one of the plurality of assortment packs of the third set of the plurality of assortment packs based at least in part on the second maximum number of items such that a number of a plurality of items included in each assortment pack of the fourth set of the plurality of assortment packs is less than the second maximum number of items.

16. The method of claim 1,
wherein each assortment pack of the first set of the plurality of assortment packs is associated with one respective physical package,
wherein each assortment pack of the third set of the plurality of assortment packs is associated with one respective physical package,
wherein determining the first set of the plurality of assortment packs comprises determining the first set of the plurality of assortment packs without limiting a number of a plurality of items included in each assortment pack of the first set of the plurality of assortment packs,
wherein changing the distribution of the different versions of the item of at least one of the plurality of assortment packs of the first set of the plurality of assortment packs comprises changing the distribution of the different versions of the item of the at least one of the plurality of assortment packs of the first set of the plurality of assortment packs without limiting a number of a plurality of items included in each assortment pack of the second set of the plurality of assortment packs,
wherein determining the third set of the plurality of assortment packs comprises determining the third set of the plurality of assortment packs without limiting a number of a plurality of items included in each assortment pack of the third set of the plurality of assortment packs,
wherein changing the distribution of the different versions of the item of at least one of the plurality of assortment packs of the third set of the plurality of assortment packs comprises changing the distribution of the different versions of the item of the at least one of the plurality of assortment packs of the third set of the plurality of assortment packs without limiting a number of a plurality of items included in each assortment pack of the fourth set of the plurality of assortment packs,
the method further comprising:
for each assortment pack of the second set of the plurality of assortment packs:
determining whether the number of the plurality of items included in the respective assortment pack is greater than a first maximum number of items; and
responsive to determining that the number of the plurality of items included in the respective assortment pack is greater than the first maximum number of items, associating the respective assortment pack with multiple physical packages such that a number of a plurality of items included in each of the multiple physical packages is less than the first maximum number of items; and
for each assortment pack of the fourth set of the plurality of assortment packs:
determining whether the number of the plurality of items included in the respective assortment pack is greater than a second maximum number of items; and
responsive to determining that the number of the plurality of items included in the respective assortment pack is greater than the second maximum number of items, associating the respective assortment pack with multiple physical packages such that a number of a plurality of items included in each of the multiple physical packages is less than the second maximum number of items.

17. The method of claim 1, further comprising:
for each cluster of retail stores of the first plurality of clusters of retail stores:
determining, with the computing device, whether a number of retail stores included in the respective cluster of retail stores is less than a first threshold value; and
responsive to determining that the number of retail stores included in the respective cluster of retail stores is less than the first threshold value, associating each retail store included in the respective cluster of retail stores with an assortment pack, different than the assortment pack with which the retail stores of the respective cluster of retail stores have been associated, such that a number of clusters of the first plurality of clusters of retail stores is decreased; and
for each cluster of retail stores of the second plurality of clusters of retail stores:
determining, with the computing device, whether a number of retail stores included in the respective cluster of retail stores is less than a second threshold value; and
responsive to determining that the number of retail stores included in the respective cluster of retail stores is less than the second threshold value, associating each retail store included in the respective cluster of retail stores with an assortment pack, different than the assortment pack with which the retail stores of the respective cluster of retail stores have been associated, such that a number of clusters of the second plurality of clusters of retail stores is decreased.

18. A computing device, comprising:
at least one computer-readable storage device; and
at least one processor configured to access information stored on the at least one computer-readable storage device and to perform operations comprising:
determining a first set of assortment packs that include a plurality of different versions of an item to be sold at a plurality of retail stores based at least in part on forecasted sales of the item at each of the plurality of retail stores;
for each retail store of the plurality of retail stores, associating the retail store with an assortment pack of the first set of assortment packs based at least in part on the forecasted sales of the item at the retail store such that the plurality of retail stores is grouped into a first plurality of clusters of retail stores;
changing a distribution of the different versions of the item of at least one of the plurality of assortment packs of the first set of assortment packs based at least in part on the forecasted sales of the item at each retail store of the cluster of retail stores of the first plurality of clusters of retail stores with which the at least one of the plurality of assortment packs of the first set of assortment packs has been associated so as to determine a second set of assortment packs;
determining a third set of assortment packs that include a plurality of different versions of the item to be sold at the plurality of retail stores based at least in part on forecasted sales of the item at each of the plurality of retail stores;
for each retail store of the plurality of retail stores, associating the retail store with an assortment pack of the third set of assortment packs based at least in part on the forecasted sales of the item at the retail store such that the plurality of retail stores is grouped into a second plurality of clusters of retail stores;
changing a distribution of the different versions of the item of at least one of the plurality of assortment packs of the third set of assortment packs based at least in part on the forecasted sales of the item at each retail store of the cluster of retail stores of the second plurality of clusters of retail stores with which the at least one of the plurality of assortment packs of the third set of assortment packs has been associated so as to determine a fourth set of assortment packs;
comparing the second set of assortment packs and the fourth set of assortment packs; and
selecting one of the second set of assortment packs and the fourth set of assortment packs based on the comparison.

19. The computing device of claim 18, wherein the at least one processor is configured to perform operations further comprising:
for each retail store of the plurality of retail stores, associating the retail store with an assortment pack of the second set of assortment packs based at least in part on the forecasted sales of the item at each retail store such that the plurality of retail stores is grouped into a third plurality of clusters of retail stores;
changing the distribution of the different versions of the item of at least one of the plurality of assortment packs of the second set of assortment packs based at least in part on the forecasted sales of the item at each retail store of the cluster of retail stores of the third plurality of clusters of retail stores with which the at least one of the plurality of assortment packs has been associated so as to determine a fifth set of assortment packs;
for each retail store of the plurality of retail stores, associating the retail store with an assortment pack of the fourth set of assortment packs based at least in part on the forecasted sales of the item at each retail store such that the plurality of retail stores is grouped into a fourth plurality of clusters of retail stores; and
changing the distribution of the different versions of the item of at least one of the plurality of assortment packs of the fourth set of assortment packs based at least in part on the forecasted sales of the item at each retail store of the cluster of retail stores of the fourth plurality of clusters of retail stores with which the at least one of the plurality of assortment packs has been associated so as to determine a sixth set of assortment packs.

20. The computing device of claim 19, wherein the at least one processor is configured to perform operations further comprising:
comparing the fifth set of assortment packs and the sixth set of assortment packs; and
selecting one of the fifth set of assortment packs and the sixth set of assortment packs based on the comparison.

21. The computing device of claim 18, wherein the at least one processor is configured to perform operations further comprising:
determining that a stopping condition is satisfied; and
responsive to determining that the stopping condition is satisfied, outputting:
an indication of the selected one of the second set of assortment packs and the fourth set of assortment packs; and
for each retail store of the plurality of retail stores, an indication of the assortment pack of the selected one of the second set of assortment packs and the fourth set of assortment packs with which the retail store has been associated.

22. The computing device of claim 18, wherein each cluster of the first plurality of clusters of retail stores comprises a plurality of retail stores that have each been associated with the same assortment pack of the second set of assortment packs, and wherein each cluster of the second plurality of clusters of retail stores comprises a plurality of retail stores that have each been associated with the same assortment pack of the fourth set of assortment packs.

23. The computing device of claim 18, wherein the at least one processor is configured to perform operations further comprising:
determining, for each assortment pack of the second set of assortment packs, a difference between the distribution of the different versions of the item and a distribution of the forecasted sales of the different versions of the item at each retail store of the cluster of retail stores of the first plurality of clusters of retail stores with which the assortment pack has been associated so as to determine a first plurality of distribution differences; and
determining, for each assortment pack of the fourth set of assortment packs, a difference between the distribution of the different versions of the item and a distribution of the forecasted sales of the different versions of the item at each retail store of the cluster of retail stores of the second plurality of clusters of retail stores with which the assortment pack has been associated so as to determine a second plurality of distribution differences,
wherein comparing the second set of assortment packs and the fourth set of assortment packs comprises comparing the first plurality of distribution differences and the second plurality of distribution differences.

24. The computing device of claim 22,
wherein comparing the first plurality of distribution differences and the second plurality of distribution differences comprises:
determining a first average distribution difference of the first plurality of distribution differences;
determining a second average distribution difference of the second plurality of distribution differences; and
comparing the first average distribution difference and the second average distribution difference to determine a least average distribution difference, and
wherein selecting one of the second set of assortment packs and the fourth set of assortment packs comprises selecting the one of the second set of the plurality of assortment packs and the fourth set of assortment packs that is associated with the least average distribution difference.

25. A computer-readable storage device encoded with instructions that, when executed, cause one or more processors of a computing device to:
determine a first set of assortment packs that include a plurality of items to be sold at a plurality of retail stores based at least in part on forecasted sales of the item at each of the plurality of retail stores;
for each retail store of the plurality of retail stores, associate the retail store with an assortment pack of the first set of assortment packs based at least in part on the forecasted sales of the items at the retail store such that the plurality of retail stores is grouped into a first plurality of clusters of retail stores;
change the items of at least one of the assortment packs of the first set of assortment packs based at least in part on the forecasted sales of the items at each retail store of the cluster of retail stores of the first plurality of clusters of retail stores with which the at least one of the assortment packs of the first set of assortment packs has been associated so as to determine a second set of assortment packs;
determine a third set of assortment packs that include a plurality of items to be sold at the plurality of retail stores based at least in part on forecasted sales of the item at each of the plurality of retail stores, wherein the third set of assortment packs is different than the first set of assortment packs;
for each retail store of the plurality of retail stores, associate the retail store with an assortment pack of the third set of the plurality of assortment packs based at least in part on the forecasted sales of the items at the retail store such that the plurality of retail stores is grouped into a second plurality of clusters of retail stores;
change the items of at least one of the assortment packs of the third set of assortment packs based at least in part on the forecasted sales of the items at each retail store of the cluster of retail stores of the second plurality of clusters of retail stores with which the at least one of the assortment packs of the third set of assortment packs has been associated so as to determine a fourth set of assortment packs; and
select one of the second set of assortment packs and the fourth set of assortment packs based on a comparison of a difference between the items of each assortment pack in the second set of assortment packs and the forecasted sales of the items at each retail store of the cluster of retail stores of the first plurality of clusters of retail stores with which each assortment pack has been associated and a difference between the items of each assortment pack in the fourth set of assortment packs and the forecasted sales of the items at each retail store of the cluster of retail stores of the second plurality of clusters of retail stores with which each assortment pack has been associated.
